(19) United States
(12) Patent Application Publication
(10) Pub. No.: US 2026/0178904 A1
(43) Pub. Date: Jun. 25, 2026

(54) METHODS AND SYSTEMS FOR DETERMINING CONTRIBUTION VALUE OF CONTENT USED TO TRAIN MACHINE LEARNING MODELS

(71) Applicant: VALENT TECHNOLOGIES, INC., Brookline, MA (US)

(72) Inventors: Alejandro Tomas Perez, Boston, MA (US); Anna Boone Reighart, Boston, MA (US); Louis Walter Hunt, Boston, MA (US)

(21) Appl. No.: 19/430,158

(22) Filed: Dec. 22, 2025

Related U.S. Application Data
(60) Provisional application No. 63/738,452, filed on Dec. 23, 2024.

(51) Int. Cl. G06N 3/08

(52) U.S. Cl. CPC G06N 3/08

(57) ABSTRACT

Disclosed are methods and systems for determining the contribution value of content used to train a machine learning model and for detecting whether specific content was used in model training. In some embodiments, a processor encodes input sequences and ground truths, performs a plurality of tests for rarity or salience, and combines test results to quantify contribution value. The approach may support various data types and enables efficient, reproducible assessment of informational value for content attribution, licensing, and compliance.

### CROSS-REFERENCE TO RELATED APPLICATIONS

The present application claims the benefit of and priority to U.S. Provisional Patent Application No. 63/738,452, filed in the United States Patent and Trademark Office on Dec. 23, 2024, and titled “Detecting Whether a Machine Learning Model was Trained on a Given Data Point,” the entire contents of which is incorporated herein by reference in its entirety for all purposes.

### BACKGROUND

There is currently no objective or standardized method for determining the contribution value (also referred to as information gain or utility) that a particular data or content provides to a machine learning model during all stages of model development and deployment, e.g., pre-training, fine-tuning, reinforcement learning, in-context learning, inference, or other stages. Contribution value represents the ability of a given data or content and its representative encodings to impact model performance as measured by a relevant objective function. The objective function depends on the stage of model development. For example, during the training or fine-tuning process, contribution value refers to a data's ability to enhance model performance-commonly measured by how much it reduces cross-entropy loss. During inference or in-context learning, contribution value refers to the ability of the data input into the context window to efficiently improve the model's output. Although identifying and prioritizing data with high contribution value can minimize the number of tokens/encodings needed for model development and performance—by reducing training steps, lowering development and inference costs and time—organizations struggle to identify and measure impactful data with high contribution value. This challenge extends to memory and storage optimization, as models allocate substantial resources based on the assumption that many tokens are needed for each training and inference step. The industry's inability to identify and measure data with high contribution value remains a significant barrier to achieving optimal model performance and resource savings including for compute, energy, memory, storage and labor (time needed for humans in the loop during reinforcement learning).

Machine learning faces another critical problem due to the lack of an objective or standardized method for determining the contribution value or information gain that a particular content provides to a machine learning model. This problem has become acute due to large-scale legal battles between AI companies and content owners over copyright infringement, with approximately 65 copyright lawsuits filed against AI companies as of December 2025. Current approaches to detect training data or to quantify the contribution value of input data during inference have limited accuracy. The lack of efficient attribution/identification and valuation mechanisms is impeding the development of an efficient market for content (or data) licensing, despite demonstrated demand from both AI companies and content owners for a functioning marketplace.

Machine learning models, and in particular large-scale generative models, such as language models, are increasingly trained on vast and diverse datasets comprising text, audio, images, video, music, and other forms of digital content. These models are widely used in a variety of applications, including natural language processing, content generation, information retrieval, and automated decision-making. The training of such models typically involves the use of substantial volumes of content, some of which will be protected by intellectual property rights, such as copyright. As the adoption of generative models has grown, so too has the demand for content to train on and the need for effective mechanisms to attribute and value the contribution of specific content used during model training. Likewise, as models have become increasingly advanced and able to process multiple iterative queries during inference, and as model developers have begun making concerted efforts to increase the size of their model's context window, the benefits of inputting high contribution-value data into the context window during inference have become clear, as it would lead to more efficient model inference.

This lack of transparency can result in arbitrary or inefficient disputes and resolutions (e.g. licensing arrangements) between model developers and content owners, and impede the development of efficient markets for content licensing. Additionally, there is a need for reliable techniques to determine, from outside the training process, whether a specific content item was used to train a given model, or was used to fine-tune a given model, or was used as context while a given model generated an output. Without such mechanisms, it can be difficult for content owners to enforce their rights or for model developers to demonstrate compliance with licensing requirements. These challenges are further complicated by the technical characteristics of modern models, which may memorize, interpolate, or compress information in ways that are not readily apparent from their outputs.

In some instances, existing approaches for evaluating content contribution or detecting training data usage rely on indirect measures, such as model perplexity, loss values, or similarity metrics, which do not accurately reflect the true informational value or provenance of the content. As a result, there remains a need for improved methods and systems that can efficiently and fairly determine how much value a piece of content contributes to a model, as well as detect whether specific content was used during model training. Such solutions would support unbiased determinations of content valuations for compensation for model developers, content owners and other AI companies, enable more effective attribution, enable more efficient model development and inference, and facilitate the formation of a robust and efficient content licensing market for AI model training and use, which does not exist today.

A technical understanding of language models may be helpful in appreciating the critical challenges associated with content attribution and valuation. As discussed in more detail with respect to FIG. 1, language models typically operate by encoding input sequences into tokens or “encodings” using an encoder or tokenizer. The following terms ‘encodings’ and ‘tokens’ are used interchangeably throughout the present disclosure, referring to the unique identifier for a word, subword, symbol, pixel, or other unit of non-textual data within a model's vocabulary. These input sequences are used by the model to generate output token sequences based on learned patterns from the training data. The model assigns prediction scores, or logits, to each token in its vocabulary at each generation step, and these logits are subsequently used to generate output tokens. The process of training a language model or running the model during inference generally involves minimizing or maximizing the value calculated by an objective function. It is common for the objective to be loss minimization, where loss is calculated by a function, such as cross-entropy, which encourages the model to accurately predict the next token in a sequence. In practice, models may use random number generators and temperature scaling to introduce variability and reduce the likelihood of verbatim regurgitations of memorized training data. However, it is still possible for models to reproduce sequences that closely match or exactly replicate content seen during training, especially for unique or rare inputs.

Current approaches for detecting training or in-context data using techniques such as membership inference have limitations, including reliance on probability estimates that can be misleading due to softmax normalization and temperature scaling procedures. Existing methods often operate on processed outputs rather than raw logit values, leading to reduced accuracy. The field lacks reliable techniques that can efficiently identify whether specific datapoints were seen during model training or inference without access to the original training dataset. Previous approaches using perplexity, compression ratios, and n-gram analysis have shown limited effectiveness, particularly when models employ sophisticated output processing or alignment techniques to prevent regurgitation of training data.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Various embodiments described herein provide methods and systems for determining the contribution value of content used by a machine learning model, as well as for detecting whether specific content was used in model training or during inference. In general, the disclosed techniques involve receiving a model encoder for a target model and encoding the target content for analysis into a sequence of encodings which represent ground truth. A plurality of tests are defined and then performed in relation to a target model using each input sequence to obtain one or more corresponding output token sequences. These tests may include determinations for rarity or salience, and the results of the tests for each output sequence are combined to obtain a value that represents the expected contribution of the sequence to the model. The contribution values for the token sequences of the content are then aggregated to yield a value representative of the overall contribution value of the content to the model.

A person skilled in the art will appreciate the term “sequence” is not limited to a set of vector encodings or embeddings representing text tokens, but can also include encodings or embeddings representing, for example, images, audio signals, video frames, time series data, and/or any other form of data that can be processed by the model to condition its output and/or behavior. In some implementations, the input sequence may include various data types, including text, audio, video, images, music, or other forms of data. The plurality of tests can be performed in a sorted order, and may be executed until a sufficient level of confidence is determined. Tests may be ranked based on their expected value to ensure that sufficient confidence is reached efficiently. The types of tests performed may further include determinations for significance, entropy, weight of evidence, or explanatory power. In certain approaches, tests for significance and entropy can be used to determine the sorted order of the tests, and the process of combining test results may also incorporate determinations for these metrics. Significance and entropy determinations may involve comparing output token sequences with ground truth token sequences for a corresponding input sequence, while weight of evidence and explanatory power determinations may involve comparisons of values assigned to all entries in a given model vocabulary.

In some embodiments, the model may include a random number generator and a seed for the random number generator, enabling the determination of whether one or more output token sequences for a corresponding input sequence are verbatim to the ground truth. The system may store the input sequence, the verbatim output token sequences, and the seed used for the model to facilitate reproducibility and further analysis. The processor used for these operations may include a graphics processing unit (GPU) and/or a central processing unit (CPU), and may be located locally on a computer or remotely on a cloud-based server system (e.g., in the cloud).

In further embodiments, methods and systems are provided for determining whether content was used by a model during training or inference. These methods may include evaluating the results of the plurality of tests for each input sequence to determine whether the input sequence was used during model training. This evaluation may include checking for verbatim output and storing the relevant input sequence and seed. The results of these determinations may be combined to obtain values representative of the expected contribution of token sequences and the overall content to the model.

The disclosed methods and systems enable efficient, granular, and reproducible assessment of the informational value of content relative to a machine learning model, supporting applications in content attribution, licensing, compliance, model training efficiency, and model inference efficiency. Features from any of the above-mentioned embodiments may be used in combination with one another in accordance with the general principles described herein. These and other embodiments, features, and advantages will be more fully understood upon reading the following detailed description in conjunction with the accompanying drawings and claims.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram illustrating the encoding of a datapoint into a token sequence.

FIG. 2A is a system overview diagram illustrating a local computer implementation of the present disclosure for determining contribution values of content used to train a model.

FIG. 2B is a system overview diagram illustrating a cloud-based implementation of the present disclosure for determining contribution values of content used to train a model.

FIG. 3 is a flow chart illustrating a method for determining contribution values of content used to train a model.

FIG. 4 is a flow chart illustrating a method for determining and reporting on verbatim outputs and contribution value to train a model.

FIG. 5 is a flow chart illustrating a method of determining a contribution value of content (whether or not verbatim outputs) used to train a model.

FIG. 6 is a flow chart illustrating a method for determining and reporting contribution values of content used to train a model (whether verbatim or not), including steps for sorting tests for execution.

FIG. 7 is a diagram illustrating an example of an original input sequence and output verbatim with corresponding token sequences.

FIG. 8 is a flow chart illustrating a method for determining when sufficient test data has been collected to evaluate the uniqueness of a datapoint for a model.

FIG. 9 is a flow diagram illustrating a method for determining whether sufficient confidence has been achieved in contribution value determinations for content evaluated by a model.

FIG. 10 is a schematic illustration showing how a text datapoint is segmented into multiple input and expected-output test pairs for evaluation by a model.

FIG. 11 is a schematic diagram illustrating enumeration of tests from a datapoint and sorting of the tests for evaluation by an ordering function G(E).

FIG. 12 is a schematic diagram illustrating test execution and logging for multiple model queries using different seeds and comparing token output sequences to ground truth token sequences.

FIG. 13 is a schematic diagram illustrating execution of a test on a model to compute contribution values for a datapoint.

FIG. 14 shows example equations for value contribution calculations of a datapoint.

FIG. 15 illustrates Shannon entropy equations used to characterize encoded/tokenized sequences.

FIG. 16 illustrates equations used for Fisher Information calculations.

FIG. 17 illustrates a weight of evidence equation used for evaluating tests.

FIG. 18 illustrates explanatory power and information value equations as expressed through mutual information formulations and their equivalent representations.

FIGS. 19 and 20 relate to the workflow for obtaining a sorted test sequence by the G(.) function.

### DETAILED DESCRIPTION

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting.

There is a need for methods and systems that can analyze the relationship between input content and model outputs at the token/encoding level, evaluate the rarity, salience, and significance of specific sequences, and combine these results to quantify the contribution value of content to a model. Such approaches also support the detection of whether particular content was used by a model during training or inference, even in the presence of stochastic generation procedures or post-training modifications. By addressing these needs, improved solutions can provide a foundation for optimal model performance and resource savings including for compute, energy, memory and storage, as well as content attribution, transparent content valuation, and an efficient market place for content in the context of machine learning model development and deployment.

Machine learning models that use data/content that has high contribution value during training or inference offer significant advantages in terms of efficiency, performance, and resource management. When data/content leads to a more substantial reduction in loss, improved accuracy in less time, or minimization/maximization of values measured by a given objective function, it possesses a higher contribution value, meaning it directly improves the efficiency of the model's learning process, inference and other outcomes. Importantly, if two data sequences yield the same overall improvement but differ in length, the tokens/encodings in the shorter data sequence (having fewer) carry a higher per-token (or per-encoding) contribution value, further boosting efficiency.

Prioritizing data with high contribution values minimizes the number of tokens or encodings required to achieve desired performance improvements. This in turn reduces the number of steps for both training and inference, each of which demands time, computational power, and energy. By decreasing the token/encoding count and focusing on more impactful data, organizations can lower the cost and duration of all stages of model development, including but not limited to model training, fine-tuning, in-context learning, and inference. Expenses associated with compute resources, energy consumption, and even human labor are all reduced when fewer, more valuable token/encodings drive model development and deployment/inference.

Beyond computational savings, high contribution value data positively impacts memory and storage requirements. Models typically allocate substantial memory under the assumption that many token/encodings are necessary per training step and for inference. However, choosing token/encodings with greater utility means less memory is needed per step, and data storage can be optimized by avoiding redundant or unnecessary data. By identifying which data has already been used, retraining on the same information can be prevented-saving storage space and computational effort. Moreover, attributing the sources of high contribution-value data allows for more targeted future training, using only the most effective datasets.

The same memory efficiency gains apply to the context window (i.e., the input given to the model when it is used). A model that has already been trained can be used with a smaller context window, without changing the model, if the data included in the context window has higher contribution value. A smaller context window means the model will use less memory while it is running, and therefore the model is more efficient at inference.

The prior approaches available lack one or more of the following advantages provided by the present disclosure:
a) ability to use derandomization techniques to characterize the internal representation and behavior of statistical and probabilistic models;
b) ability to deterministically recreate specific model outputs;
c) ability to analyze raw model output (i.e., unprocessed and unnormalized values before they are processed and converted into probabilities or encodings or embeddings);
d) ability to identify the ground truth as it is represented in the raw model output;
e) ability to measure the effects a given datapoint had or would have as they relate to the representational capacity of a given model given the information currently represented in the model parameters and weights;
f) ability to measure sufficiency and confidence in results obtained through the analysis; and
g) ability to measure and minimize the amount of computational resources needed to conclusively analyze a datapoint as it relates to a given model before the analysis begins.

Another aspect of the present disclosure is that identifying data that has low or negative contribution value is useful information for preventing unnecessary use of memory and storage resources and computational efforts. Low or negative contribution values represent data that is redundant/unnecessary/detrimental for a given model as measured by the relevant objective function. Some examples are, data the model has already seen during training (which would lead to over-fitting or wasteful computation), data the model is already familiar with during in-context learning (which would lead to unnecessary allocation of tokens in its finite context window), and data that does not lead to a higher reward during fine-tuning (which would lead to more time and resources devoted to the process). Low or negative contribution value data will likely lead to inefficient model development, deployment and use of resources.

In summary, selecting data with the highest contribution value—also referred to as information gain or utility-drives model development efficiency across all stages. Whether training, fine-tuning, in-context learning, or inference, models benefit from improved performance using fewer resources. If a model is already trained, the method can be used to select data for fine-tuning (post-training) and normal usage/inference (e.g., selecting the data that is put in the context window to answer a question). This approach not only streamlines the learning process but also leads to considerable savings in memory, storage, time, compute, and overall operational costs (including labor) across training, post-training and normal model usage/inference.

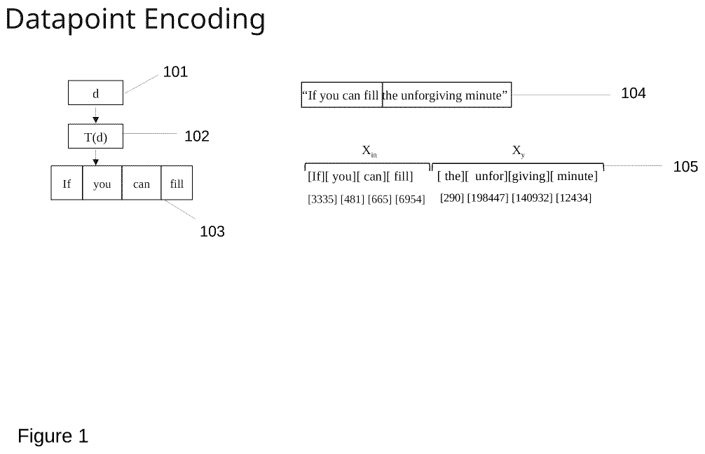

FIG. 1 is a schematic diagram that illustrates the process of encoding a raw datapoint sequence (e.g. article, book, poem, video, music score, or other data) into structured tokenized input and output representations for use in model analysis. The figure begins with a raw datapoint symbol, designated as element 101, which represents the original content or data sample to be analyzed by the system. The term “raw datapoint symbol,” as used herein, refers to any unprocessed input that serves as the starting point for subsequent encoding and analysis operations. Examples of such raw datapoint symbols may include, without limitation, sentences, paragraphs, document excerpts, images, music, video or any other form of unstructured data. In this example, the raw text is processed by a tokenization (or encoder) function, indicated as element 102, which operates to convert the input text into a sequence of discrete tokens based on a predefined vocabulary. The term “tokenization function” refers to a computational process or algorithm that segments a text sequence into constituent tokens, where each token corresponds to a unit such as a word, subword, or symbol, and is mapped to a unique identifier in the model's vocabulary. Examples of tokenization functions may include, without limitation, byte pair encoding, unigram language model tokenization, or whitespace-based token splitting. The output of the tokenization function is shown in the figure as a sequence of tokens/encodings, labeled 103, where each token is visually represented as an individual box corresponding to a segment of the original text. The figure further presents a full example text sequence, denoted by element 104, which serves as an illustrative input for demonstrating the encoding process. This example text is segmented into two primary components for analysis: an input token sequence Xᵢₙ and an output token sequence X_{y}, collectively referenced as element 105. The term “Xᵢₙ” refers to the contiguous subset of tokens derived from the initial portion of the tokenized datapoint that is provided as input to the model, while the term “X_{y}” refers to the subsequent subset of tokens that represent the ground truth completion for the given input. Examples of input token sequences may include, without limitation, the first n tokens of a sentence, a prompt extracted from a document, or a context window of tokens preceding a prediction target. Examples of output token sequences may include, without limitation, the next m tokens following the input, a completion sequence, or a reference answer for evaluation. Each token in Xᵢₙ and X_{y} is annotated with a corresponding numeric token identifier, which uniquely specifies its position in the model's vocabulary and facilitates downstream processing and evaluation. Collectively, the elements depicted in FIG. 1 illustrate the transformation of raw text into structured token sequences that are suitable for subsequent model evaluation and analysis, as described in the present disclosure. The process of encoding a datapoint in this manner enables the system to systematically partition content into input and ground truth completion sequences, assign unique identifiers to each token, and prepare the data for token-level analysis by a machine learning model. The subsequent paragraphs will further detail the roles and functions of each group of components shown in FIG. 1, and will explain how these elements support the broader system and method of the present disclosure for determining whether a model was trained on specific content or data and its content valuation using token-level analysis.

While aspects of the present disclosure are presented using encoding text into tokens (tokenizing text), the present disclosure is not limited thereto. Other types of encodings, for example, include feature maps computed by convolutional neural networks for images, audio signals, video frames, time series data, and/or any other forms of data that can be processed by the model to condition its output and/or behavior. Encodings can also jointly include more than one data type, such as image/text pairs to classify images (e.g., descriptions in text tokens alongside encoded pixels), audio/text pairs (e.g., lyrics in text tokens alongside encoded audio snippets, encoding frequency of the audio as feature vectors based on a discrete Fourier transform (DFT)), and video/text pairs (e.g., descriptions in text tokens alongside encoded video clips).

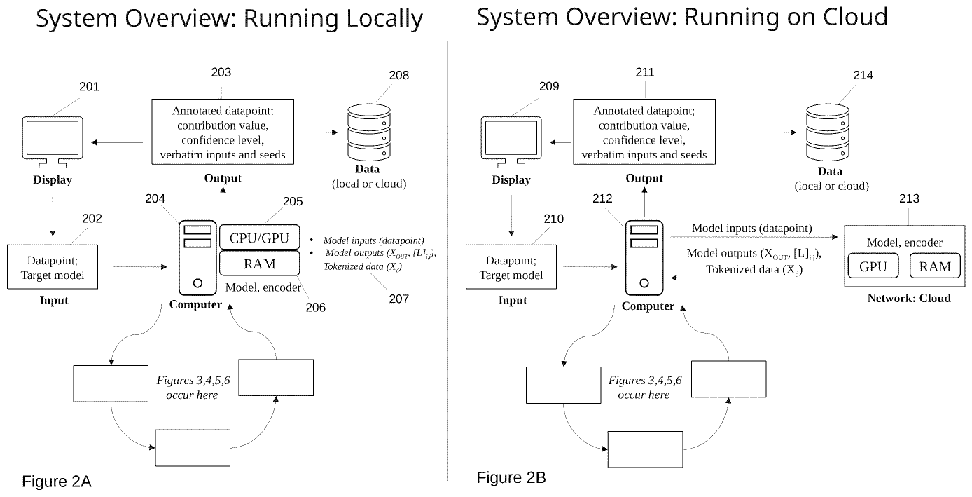

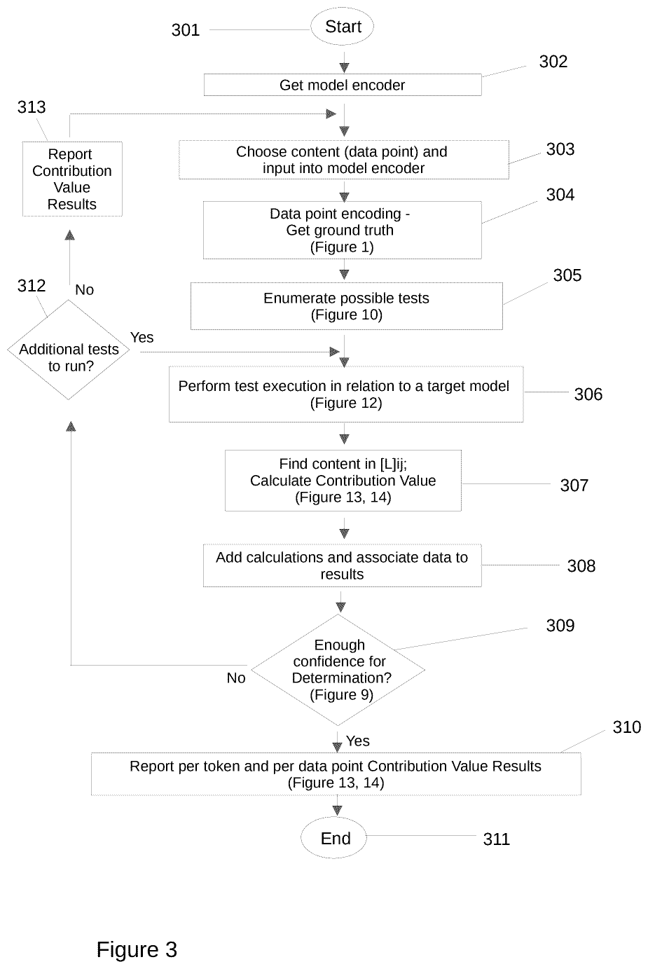

FIG. 2A and FIG. 2B provide system overview diagrams that illustrate, respectively, local and cloud-based implementations for determining attribution and contribution values of content used by a model during training or inference. In both configurations, the process begins with the provision of an input datapoint and a target model, identified as elements 202 and 210, which serve as the initial elements supplied to the system for analysis. The term “input datapoint,” as used herein, refers to any discrete unit of content or data sample that is evaluated for its informational contribution to a machine learning model. Examples of input datapoints may include, without limitation, text passages, audio clips, image files, video segments, or other forms of structured or unstructured data. The term “target model” refers to the specific machine learning or language model under evaluation for content contribution, and may include, without limitation, neural network models, transformer-based models, or other predictive computational models. In the local implementation depicted in FIG. 2A, a local computer 204 functions as the primary processing unit, equipped with computational resources such as a central processing unit (CPU) or graphics processing unit (GPU) and random access memory (RAM), referenced as elements 204, 205, and 206. The term “local computer” refers to any computing device or workstation that executes the contribution value determination of the present disclosure within a user-controlled environment. This system need not be user controlled. Examples of local computers may include, without limitation, desktop computers, laptops, or dedicated servers. The model and encoder, also represented by elements 204, 205, and 206, are responsible for processing the input datapoint and generating model outputs (represented by element 207) necessary for content attribution or contribution value analysis. The term “model and encoder” refers to the combination of a machine learning model and its associated tokenization or feature extraction mechanism, which together enable the transformation of raw input data into a format suitable for model inference. Examples of model and encoder combinations may include, without limitation, a language model paired with a byte pair encoding tokenizer, or an image classification model paired with a convolutional feature extractor. The output of the contribution value determination is an annotated datapoint, shown as element 203, which includes metrics such as contribution value, confidence level, and records of verbatim inputs and random seeds used during model evaluation. The term “contribution value” includes but is not limited to the measurement of expected information gain or utility that an unseen datapoint could provide for improving the predictive capability for a target model if used by a model during training or inference, or the information gain or utility that a seen datapoint has already contributed to the target model. The term “annotated datapoint output” refers to a data object or record that encapsulates the results of the contribution analysis, including quantitative and qualitative indicators of informational value. Examples of annotated datapoint outputs may include, without limitation, structured reports, database entries, or serialized data files containing contribution scores and associated metadata. Data storage for the local system is provided by local data storage 206 and may be extended to a local or cloud data repository 208, enabling persistent retention of both input and output data. Data storage locally or on the cloud is optional.

In the cloud-based implementation illustrated in FIG. 2B, a local computer client 212 communicates with remote computational resources over a cloud network connection 213. The term “local computer client” refers to a user-facing device that interfaces with cloud services to initiate and manage the contribution value determination process. Examples of local computer clients may include, without limitation, personal computers, tablets, or thin clients. The remote resources, which include a model and encoder hosted on cloud-based GPU and RAM infrastructure, perform the encoder and model processing and return model outputs and tokenized data to the client. An annotated datapoint output 211, is generated by the client after processing the model outputs and tokenized data. Data storage in this configuration is managed by a remote data repository 214, which may reside on cloud-based storage platforms, distributed file systems, or within local data storage. Data storage is optional.

Each of the system components described in FIG. 2A and FIG. 2B corresponds to various claim limitations regarding the use of a processor for input, a model encoder for data transformation, and optional storage elements for retaining results. Subsequent paragraphs will further detail the operations of the local and cloud systems, including the specific flow of data and the sequence of processing steps involved in determining attribution and contribution values for content used to train a model.

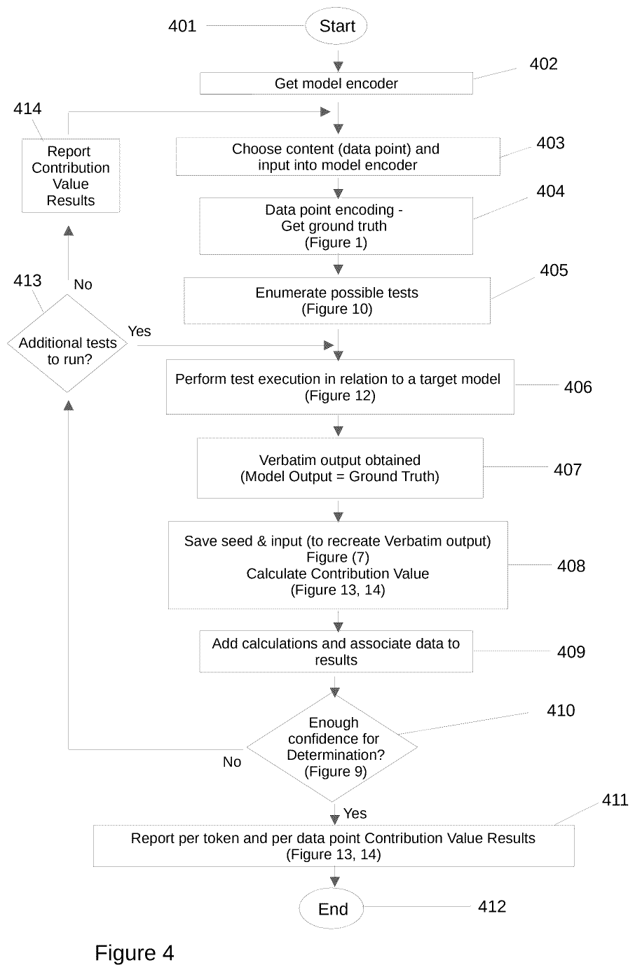

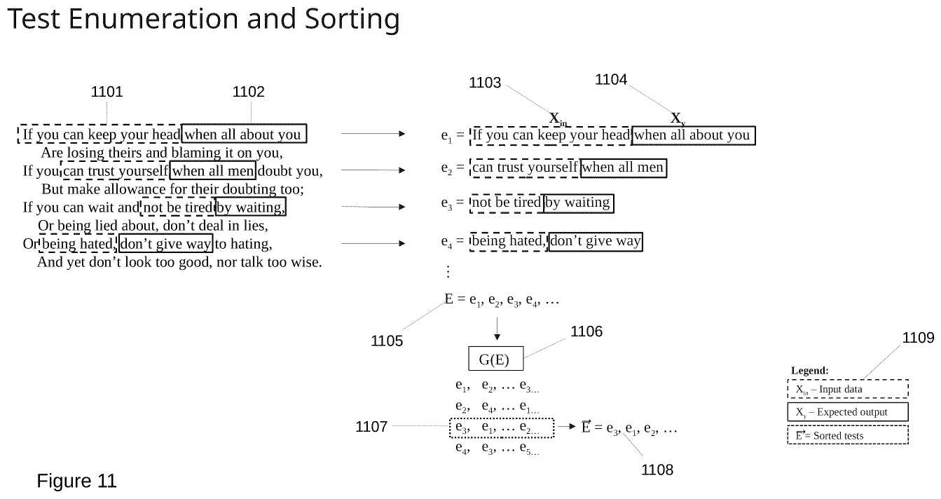

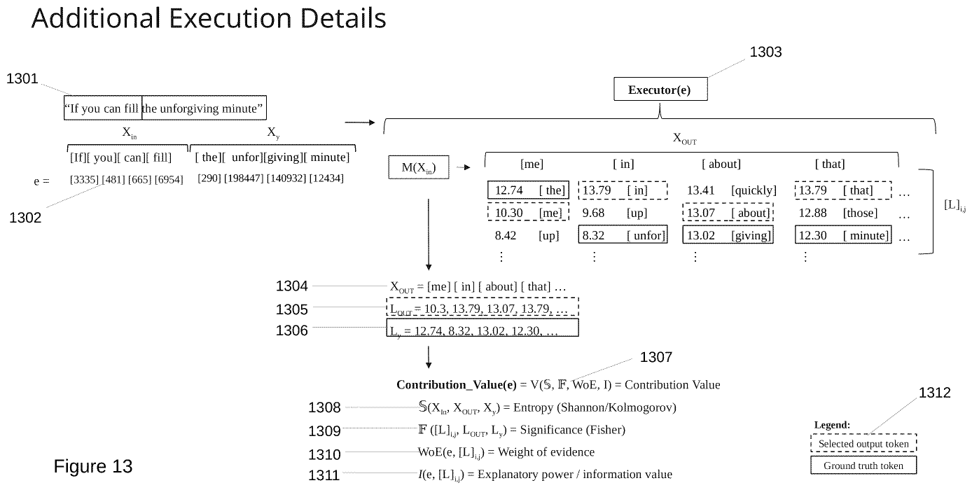

FIG. 3 is a flow chart that illustrates a method for determining contribution values of content used by a model during training or inference by depicting a sequence of process steps, each corresponding to a distinct functional component in the overall workflow. The process is bounded by a start node 301 and an end node 311, which respectively mark the initiation and completion of the contribution value determination procedure. The method begins with a ‘get model encoder’ step 302, in which the system acquires or initializes a model encoder for the target model under evaluation. The term “model encoder,” as used herein, refers to a computational module or algorithm that transforms raw input data into a structured representation suitable for processing by a machine learning model, such as converting text into token sequences or extracting features from non-textual data. Examples of model encoders may include, without limitation, tokenizers for language models, feature extractors for image or audio data, or embedding generators for structured datasets (See FIG. 1 and discussion earlier). Following this, the ‘choose content and input’ step 303 involves selecting a specific content item or datapoint and providing it as input to the model encoder. The term “content,” as used herein, refers to any data sample or information unit whose contribution to model training is to be evaluated, and may include, without limitation, text passages, audio clips, images, video frames, or other forms of digital content. The ‘data point encoding and ground truth acquisition’ step 304 entails encoding the selected content using the model encoder and obtaining the corresponding ground truth tokens for subsequent comparison. The ‘enumerate possible tests’ step 305 generates a set of tests to be performed in relation to a target model (discussed further with respect to FIG. 10), where each test assesses the model's response to a specific input sequence and its ability to generate corresponding output tokens. The ‘perform test execution in relation to a target model’ step 306 executes these tests, generating model outputs and collecting relevant metrics, which will be further discussed with reference to FIG. 12.

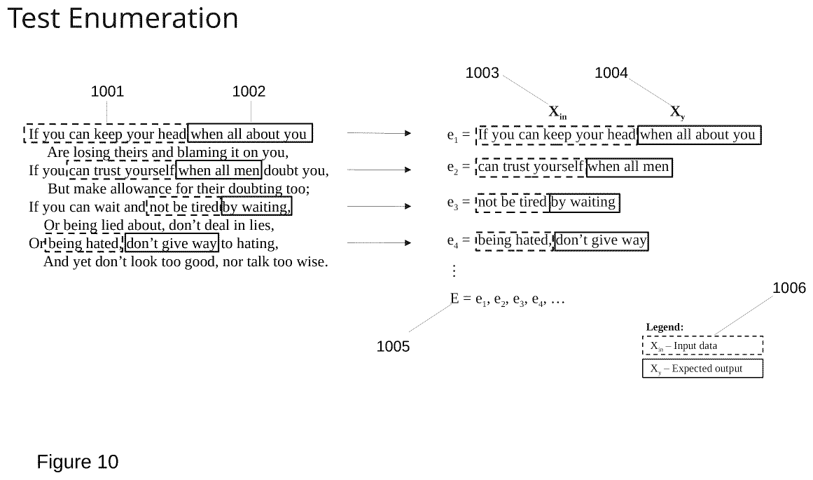

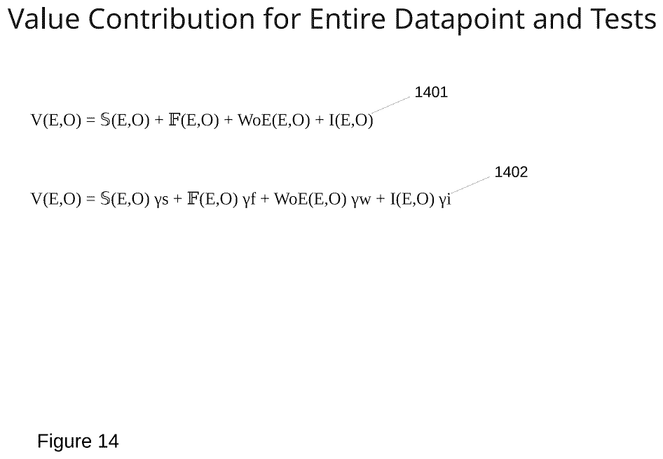

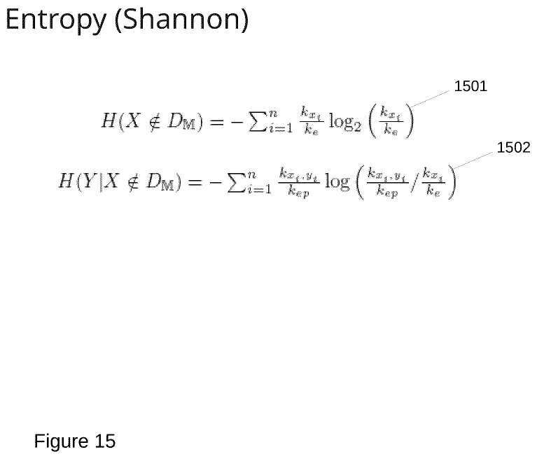

In the ‘find content in logit matrix and calculate contribution value’ step 307 (further discussed with reference to FIGS. 13, 14), the system analyzes the logit matrix produced by the model to identify relevant content and compute a contribution value for each token/encoding sequence. The term “logit matrix,” as used herein, refers to a multidimensional array or table containing the unnormalized prediction scores assigned by the model to each token in the vocabulary at each generation step. Examples of logit matrices may include, without limitation, arrays of real-valued scores output by neural network layers or tables of token-level prediction values prior to softmax normalization. The ‘add calculations and associate data to results’ step 308 aggregates the calculated contribution values and associates them with the corresponding content and test results. The ‘evaluate confidence for determination’ step 309 (further discussed with reference to FIG. 9) assesses whether the accumulated evidence is sufficient to make a reliable determination regarding the contribution value, while the ‘report per token and per data point contribution value results’ step 310 (further described with reference to FIGS. 13, 14) outputs and/or stores detailed results for each token and content item analyzed. The ‘contribution value results summary’ step 313 provides an overall summary of the findings. The additional tests to run decision branch 312 enables iterative testing by allowing the process to repeat certain steps if further evaluation is required to reach a desired confidence level. Each process step in FIG. 3 corresponds to specific claim limitations regarding receiving a model encoder, inputting content, encoding data, defining and performing tests, and combining results to determine contribution value. Subsequent paragraphs will discuss alternative process flows such as determining verbatim output, sorting the tests and others.

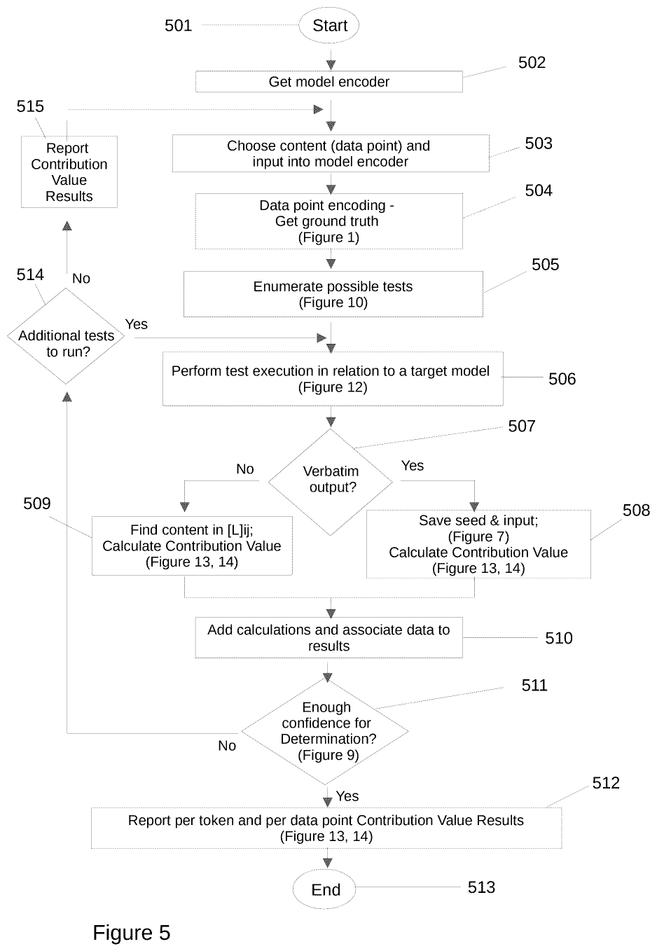

FIG. 4 is a flow chart illustrating a method for determining and reporting on verbatim outputs obtained from the model and the contribution values of the associated content used by a model during training or inference, with the process bounded by a start node 401 and an end node 412. The method performed by the processors in the FIGS. 2A, 2B, comprises a sequence of steps, beginning with obtaining a model encoder at step 402, refers to the computational module or algorithm that transforms raw input data into a structured representation suitable for processing by a machine learning model (See FIG. 1). The next step, ‘choose content and input’ at 403, involves selecting a specific content item or datapoint and providing it as input to the model encoder. As discussed earlier, the term “content,” as used herein, refers to any data sample or information unit whose contribution to model training is to be evaluated, and may include, without limitation, text passages, audio clips, images, video frames, or other forms of digital content. This is followed by data point encoding and ground truth acquisition at step 404, where the selected content is encoded and the corresponding ground truth tokens are obtained for subsequent comparison (See FIG. 1).

The method proceeds to enumerate possible tests at step 405 (See FIG. 10), defining a set of tests to be performed in relation to a target model, where each test is designed to assess the model's response to a specific input sequence and its ability to generate corresponding output token sequences. The term “test,” as used herein, refers to an evaluation instance in which a defined input sequence is provided to the model and the resulting output is analyzed for contribution value. Examples of tests may include, without limitation, input-output token pair evaluations, sequence completion tasks, or classification challenges. Step 406 involves performing test execution in relation to a target model, generating outputs and collecting relevant metrics (See FIG. 12).

At step 407, the process checks whether verbatim output has been obtained, that is, whether the model output matches the ground truth exactly. The term “verbatim output” refers to a model-generated output sequence that is identical to the expected ground truth tokens for a given input, serving as evidence of potential memorization or direct training data usage. Examples of verbatim output may include, without limitation, exact text matches, pixel-perfect image reconstructions, or byte-for-byte audio reproductions. If verbatim output is detected, step 408 saves the seed and input used to recreate the verbatim output and calculates the contribution value (See FIGS. 13, 14). The term “seed,” as used herein, refers to a value used to initialize the random number generator within the model to ensure deterministic output generation for reproducibility. Examples of seeds may include, without limitation, integer values, hash-derived values, or timestamp-based initializations. Step 409 aggregates the resulting calculations and associates the related data to overall results (e.g. FIG. 14 functions).

The process may end here and report the determination of a verbatim output and/or store the verbatim output, input sequence and associated seed. Alternatively, as shown in FIG. 4, it may alternatively proceed to a decision point at step 410, which evaluates whether there is enough confidence for a determination regarding the contribution value. If sufficient confidence is not reached (See FIG. 9), the process checks at step 413 whether additional tests remain to be run; if so, the method loops back to perform further testing, and if not, proceeds to step 414 to report and/or store contribution value results. When the confidence condition is satisfied, the method proceeds to step 411 to report per-token and per-data point contribution value results before terminating at end node 412. This flow chart highlights key decision points for confidence evaluation and additional testing, and correlates to claim limitations regarding verbatim output detection, seed storage, and contribution value calculation. Subsequent paragraphs will address further variations to the process flow of the present disclosure.

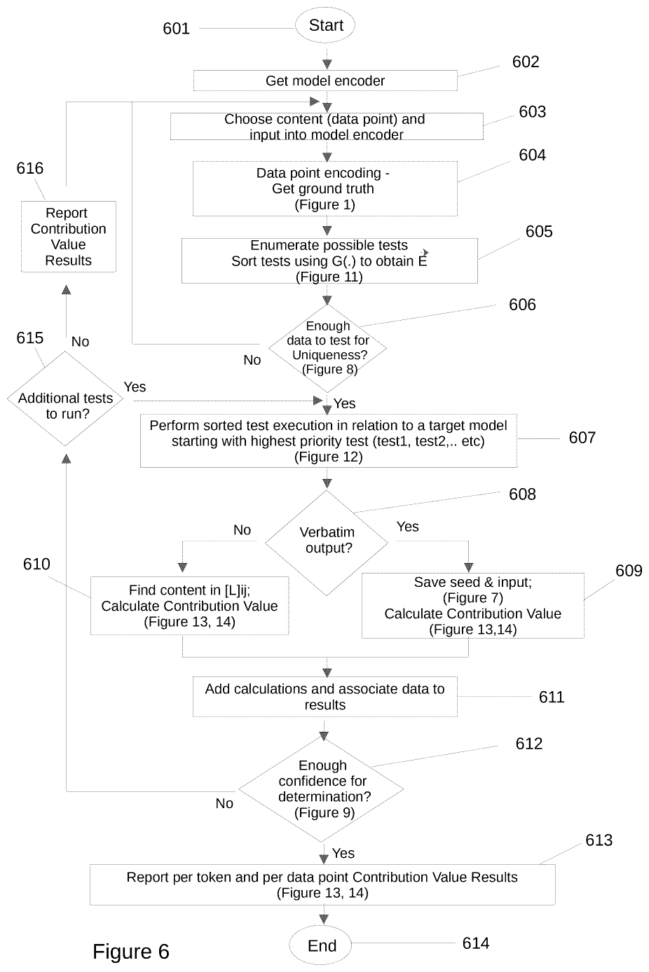

FIG. 5 is a flow chart illustrating a method, similar to ones discussed with reference to FIGS. 3 and 4, of determining a contribution value of content used by a model during training or inference, depicting a sequence of process blocks and decision points that collectively define the evaluation workflow. This process determines the contribution value of the content regardless of whether verbatim outputs were identified.

The process initiates at a start node 501 and concludes at an end node 513, establishing the boundaries of the method. The method begins with a ‘get model encoder’ step 502, in which the system acquires or initializes a model encoder for the target model under evaluation. Following this, the ‘choose content and input’ step 503 involves selecting a specific content item or datapoint and providing it as input to the model encoder. The ‘data point encoding and ground truth acquisition’ step 504 entails encoding the selected content using the model encoder and obtaining the corresponding ground truth tokens for subsequent comparison. The ‘enumerate possible tests’ step 505 defines a set of tests to be performed in relation to a target model, where each test is designed to assess the model's response to a specific input sequence and its ability to generate corresponding output token/encoding sequences. The term “test,” as used herein, refers to an evaluation instance in which a defined input sequence is provided to the model and the resulting output is analyzed for contribution value. At decision point 507, the method evaluates whether the model output is verbatim, that is, whether the generated output matches the ground truth exactly. The term “verbatim output” as discussed earlier refers to a model-generated output sequence that is identical to the ground truth tokens for a given input, serving as evidence of potential memorization or direct training data usage. Examples of verbatim output may include, without limitation, exact text matches, pixel-perfect image reconstructions, or byte-for-byte audio reproductions. If verbatim output is detected, the process proceeds to step 508, where the seed and input used to recreate the verbatim output are optionally saved and the contribution value is calculated. If the output is not verbatim, the method advances to step 509, where the system analyzes the logit matrix produced by the model to identify relevant content and compute a contribution value for each output token/encoding sequence (See FIGS. 13, 14). The term “logit matrix” refers to a multidimensional array or table containing the unnormalized prediction scores assigned by the model to each token in the vocabulary at each generation step. Examples of logit matrices may include, without limitation, arrays of real-valued scores output by neural network layers or tables of token-level prediction values prior to softmax normalization. The add calculations and associate data to results step 510 aggregates the calculated contribution values and associates them with the corresponding content and test results. The confidence level determination decision point 511 assesses whether the accumulated evidence is sufficient to make a reliable determination regarding the contribution value. If sufficient confidence is reached, the report per token and per data point contribution value results step 512 outputs (and/or stores) detailed results for each token and content item analyzed. If further evaluation is required, the additional tests to run decision point 514 enables iterative testing by allowing the process to repeat certain steps, and the report contribution value results step 515 provides an overall summary of the findings.

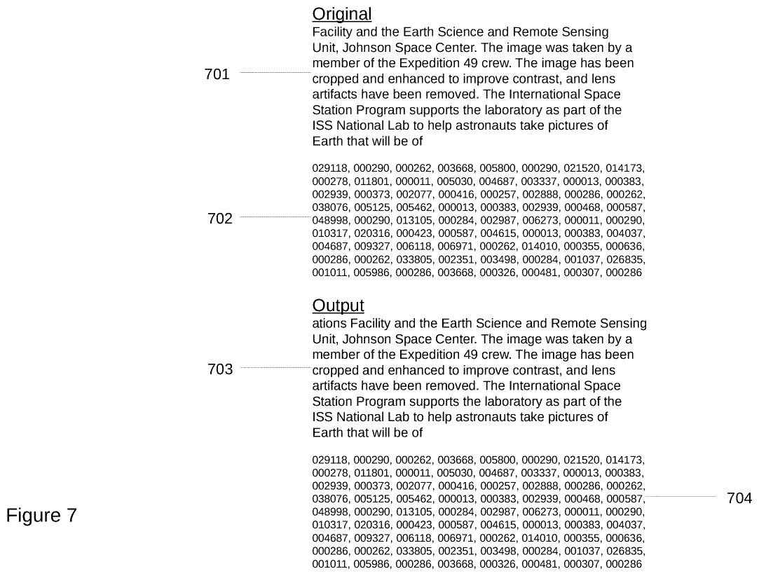

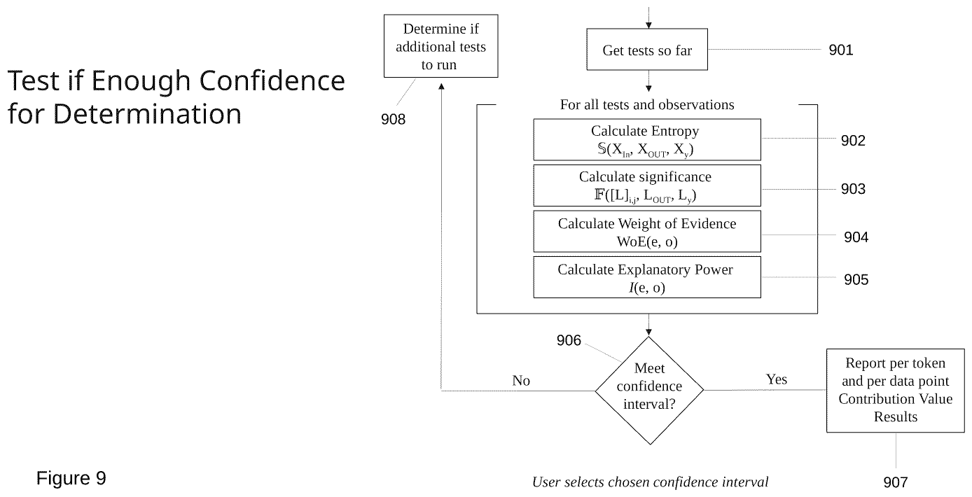

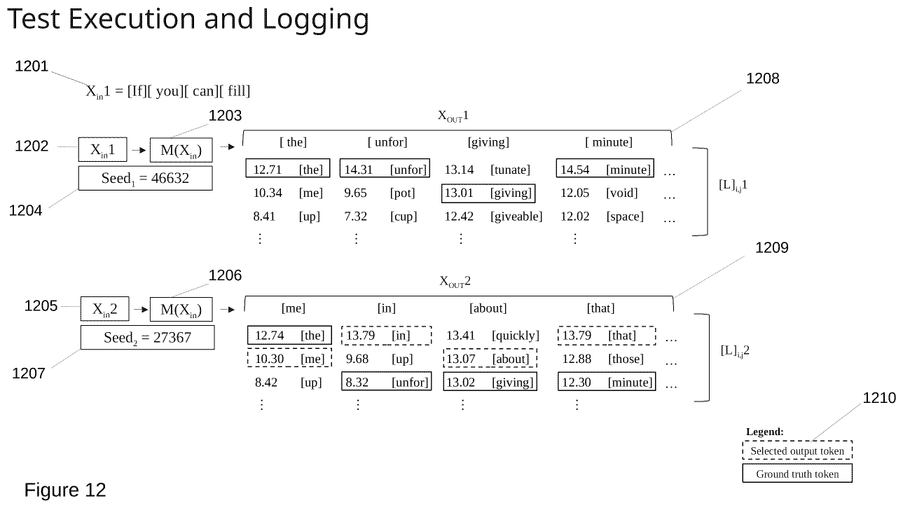

FIG. 6 is a flow chart that illustrates a method for determining and reporting contribution values of content used by a model during training or inference, with particular emphasis on the sorting and prioritization of tests (See FIG. 11). The process begins at a start node 601 and concludes at an end node 614, delineating the operational boundaries of the method. The method comprises a series of process steps, including obtaining a model encoder at step 602, choosing content and input at step 603, encoding the data point and acquiring ground truth at step 604, and enumerating and sorting possible tests at step 605 using G function (discussed in detail with reference to FIG. 11). The term “test,” as used herein, refers to a defined evaluation instance in which a specific input sequence is provided to the model and the resulting output is analyzed for contribution value. Examples of tests may include, without limitation, input-output token pair evaluations, sequence completion tasks, or classification challenges. At step 606, a decision block evaluates whether sufficient data is available to test for uniqueness (See FIG. 8), and if so, the method proceeds to perform sorted test execution at step 607, beginning with the highest priority test as determined by the sorting function. The term “sorting function,” as used herein, refers to a computational process that ranks or orders tests based on criteria such as expected information value, rarity, or salience, with the purpose of optimizing the sequence in which tests are performed to maximize efficiency and confidence in the results. Examples of sorting functions may include, without limitation, algorithms that prioritize tests with rare token combinations, high expected contribution value, or maximal explanatory power. The process continues with a verbatim output decision at step 608, followed by either saving the seed and input sequence and calculating contribution value at step 609 if verbatim output is determined, or if not verbatim, finding content in the logit matrix and calculating contribution value at step 610. Calculations are then aggregated and associated with results at step 611, and a determination is made at step 612 as to whether a sufficient confidence level has been achieved for a final determination. If so, the method reports (and/or stores) per token and per data point results at step 613; otherwise, it evaluates at step 615 whether additional tests remain to be run, and if not, proceeds to report overall contribution value results at step 616. The role of test sorting and prioritization is central to this process, as it enables the system to efficiently allocate computational resources and reach determinations with high confidence using a minimal number of tests. This approach correlates to claim limitations regarding the performance of tests in a sorted order and the evaluation of confidence in test results.

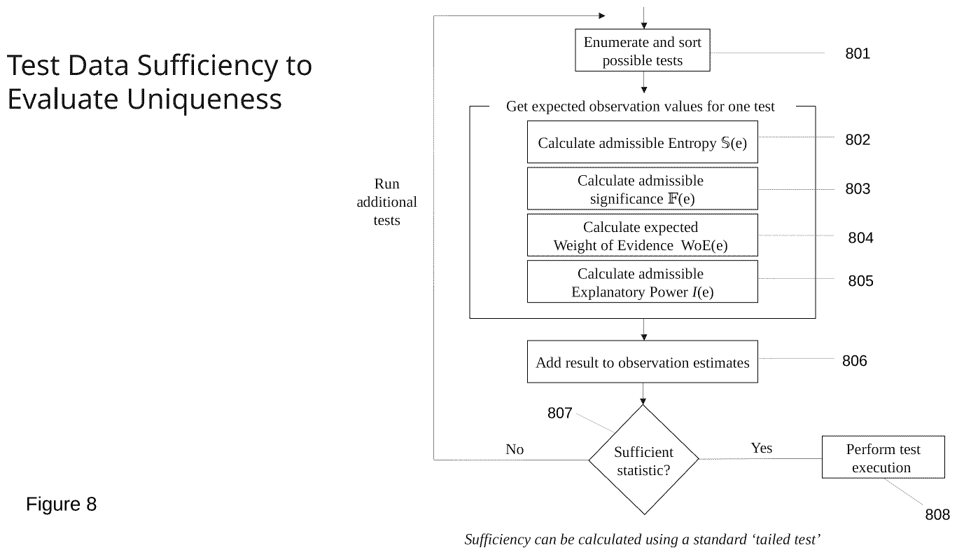

FIG. 7 is a diagram illustrating a model's ability to generate an output token sequence that is a verbatim match to the ground truth output sequence (further explained through the code snippet in Table A below). This diagram was created by a seeded deterministic language model, for which the specific code is referenced below. The figure presents an original input text passage 701, which serves as the source content for analysis, and a corresponding tokenized representation 702, where each token in the passage is mapped to a unique numeric identifier according to the model's vocabulary. The term “tokenized representation,” in this example, refers to a sequence of discrete identifiers generated by applying an encoding or tokenization function to a text passage, enabling the model to process and analyze the input at the token level. Below the original input passage, 703 presents a model-generated output, where the output sequence and its token/encoding identifiers 704 indicate verbatim reproduction of the original passage. The term “verbatim output,” as used herein, refers to a model-generated output sequence that is identical to the ground truth, evidencing that the model regenerated the content exactly as it appeared in the training data or input sequence. Examples of verbatim output may include, without limitation, exact matches of text passages, code fragments, or structured data segments. The tokenized values in 704 shows the output passage, visually indicating there is a match enabled by the fixed seed and input sequence. Notably, because models generate an output one encoding at a time, the probability of a model accurately predicting a long series of consecutive encoding outputs that match a ground truth sequence is meaningful evidence that the content was used in the training data. For instance, a model might have an encoding vocabulary of ˜100,000 encodings. Thus, the likelihood of accurately predicting the correct next encoding 50 times in a row is extremely low. The following code snippet is configured to perform deterministic model generation by specifying a fixed random seed and a list of token IDs as input. The term “seed,” as used herein, refers to a value used to initialize the random number generator within the model, ensuring that the model produces the same output sequence for a given input and configuration. Examples of seeds may include, without limitation, integer values, hash-derived values, or other reproducible initialization parameters. The code snippet demonstrates how the model, when provided with the specified seed and token sequence, generates an output passage that is shown at 703, where the output text and its token/encoding identifiers 704 indicate verbatim reproduction of the original passage.

### Table A

[A001]: import torch; import transformers; import random; import numpy
[A002]: seed=75333657
[A003]: torch.cuda.empty_cache( ); torch.manual_seed(seed); torch.cuda.manual_seed(seed)
[A004]: transformers.set_seed(seed); random.seed(seed); numpy.random.seed(seed)
[A005]: tokenizer=Tokenizer.from_pretrained(“model-name”, return_dict=True)
[A006]: model=Model.from_pretrained(“model-name”, return_dict=True, torch_dtype=torch.float16, device_map=“auto”)
[A007]: model.eval( ); model.generation_config.temperature=None; model.generation_config.top_p=None
[A008]: model.generation_config.do_sample=False; model.generation_config.pad_token_id=tokenizer.pad_token_id
[A009]: t=[12, 3157, 11685, 326, 787, 510, 16322, 14717, 13, 1406, 637, 290, 7099, 33408, 560, 12586, 547, 788, 44699, 1497, 11, 4305, 262, 517, 18290, 12586, 7362, 284, 1296, 262, 1944, 12, 820, 1956, 23914, 13, 198, 198, 47920, 14717, 318, 1807, 416, 6868, 14366, 284, 423, 587, 2727, 416, 34843, 9791, 1141, 262, 7610, 2435, 11, 543, 468, 587, 3417, 355, 262, 12799, 286, 48328, 3968, 290, 39409, 13, 383, 3881, 318, 11987, 355, 530, 286, 262, 18668, 447, 247, 749, 8036, 5207, 286, 670, 13, 13406, 21641, 3690, 663, 30923, 290, 277, 747, 942, 6901, 428, 2776, 11, 5291, 7610, 2435, 15421, 6776, 13, 383, 20387, 286, 262, 13859, 270, 73, 15712, 9443, 284, 262, 3881, 6194, 4340, 262, 8557, 4637, 1022, 262, 1957, 661, 290, 16322, 14717, 13, 198, 198, 33751, 1313, 2306, 8408, 33805, 15, 2920, 12, 36, 12, 15801, 2548, 373, 9477, 319, 2693, 2242, 11, 1584, 11, 351, 257, 31356, 360, 19, 4875, 4676, 1262, 257, 26143, 3939, 16912, 10317, 11, 290, 318, 2810, 416, 262, 33805, 17652, 3668, 19243, 602, 29118]
[A010]: _input=torch.tensor(t).unsqueeze(0).to(“cuda”)
[A011]: _att=torch.tensor([1]*len(t)).unsqueeze(0).to(“cuda”)
[A012]: with torch.no_grad( ):
[A013]: output=model.generate(input_ids=_input, max_new_tokens=253-len(t), do_sample=False, attention_mask=att, pad_token_id=model.config.eos_token_id)
[A014]: print(tokenizer.decode(output[0][len(t):]))

The elements illustrated in FIG. 7 and the code snippet in Table A, above, correspond to claim limitations relating to the use of a random number generator, the specification of a seed, and the determination of verbatim output for purposes of model evaluation.

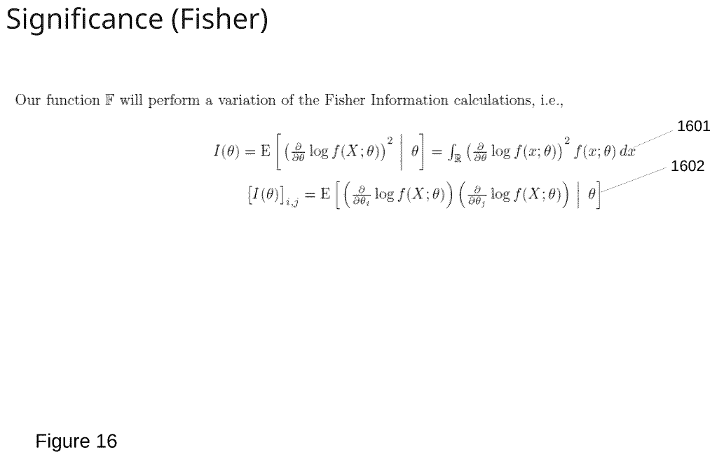

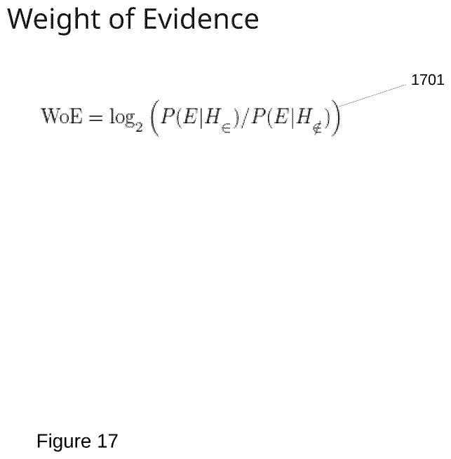

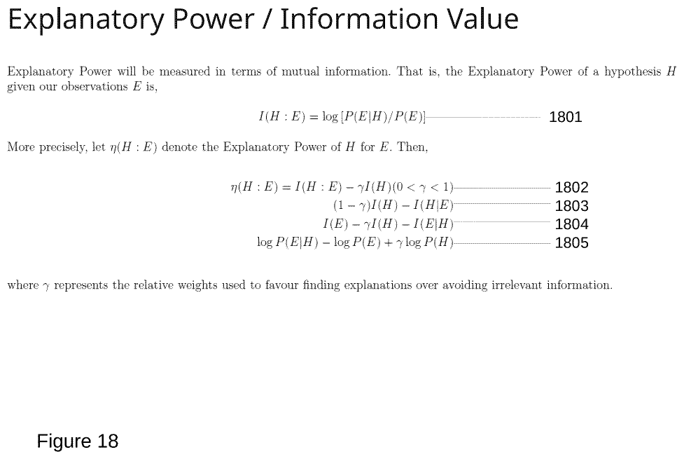

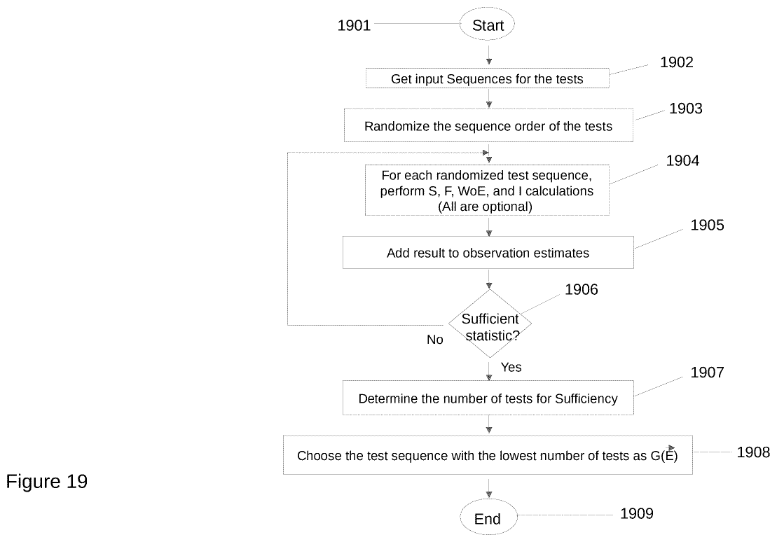

FIG. 8 is a flow chart that illustrates a method for determining when sufficient test data has been collected to evaluate the uniqueness of a datapoint for a model, with particular emphasis on the iterative evaluation process employed to reach sufficiency. The process begins with the step of enumerating and sorting possible tests, as indicated by element 801, where the system identifies a set of candidate tests to be performed and organizes them according to a prioritization strategy. Further details on the G(.) function for obtaining a sorted set of tests is provided with reference to FIGS. 11, 19 and 20. The term “test,” as used herein, refers to an evaluation instance in which a specific input sequence is provided to the model and the resulting output is analyzed for informational value and uniqueness. Examples of tests may include, without limitation, input-output token pair evaluations, sequence completion tasks, or classification challenges. Following enumeration and sorting, the method proceeds to calculate admissible entropy for each test at step 802, where entropy serves as a quantitative measure of the unpredictability or rarity of the model's output given the input (e.g. FIG. 15). The term “entropy,” as used herein, refers to a statistical metric that characterizes the degree of uncertainty or information content in a set of model outputs. Examples of entropy calculations may include, without limitation, Shannon entropy, conditional entropy, or Kolmogorov complexity-based measures. At step 803, the system calculates admissible significance for each test (e.g. FIG. 16), which involves assessing the informational value or impact of the test results on the overall determination. The term “significance,” as used herein, refers to a measure of the importance or informativeness of a test outcome in the context of model evaluation, often derived from statistical or information-theoretic criteria. Examples of significance measures may include, without limitation, Fisher Information, p-values, or confidence intervals. The next step, 804, involves calculating the expected weight of evidence for each test (e.g. FIG. 17), which quantifies the degree to which the test outcome supports or refutes the hypothesis that the datapoint is unique with respect to the model. The term “weight of evidence” refers to a log-likelihood ratio or other metric that expresses the strength of support for a given hypothesis based on observed data. Examples of weight of evidence calculations may include, without limitation, log-odds ratios, Bayes factors, or likelihood ratios. At step 805, the system calculates admissible explanatory power for each test (e.g. FIG. 18), which measures the extent to which the test results can account for or explain observed model behavior. The term “explanatory power,” as used herein, refers to the capacity of a test or set of observations to provide meaningful insight into the underlying mechanisms or properties of the model. Examples of explanatory power may include, without limitation, mutual information, information gain, or measures of model interpretability. The results of these calculations are then combined to observation estimates at step 806, where the system aggregates the information from each test to update its overall assessment. At decision point 807, the method evaluates whether a sufficient statistic has been reached, meaning that enough evidence has been collected to make a confident determination regarding the uniqueness of the datapoint. The term “sufficient statistic” refers to a summary measure or set of measures that captures all relevant information from the data needed to make a statistical inference. Examples of sufficient statistics may include, without limitation, sample means, variances, sums, squared sums, or cumulative information metrics. If the sufficiency condition is not met, the process iterates by running additional tests; if sufficiency is achieved, the method proceeds to perform test execution at step 808, thereby finalizing the evaluation. This iterative approach ensures that the system only expends computational resources as needed to reach a desired level of confidence, and directly correlates to claim limitations regarding sufficiency and confidence in testing.

FIG. 9 is a flow diagram that illustrates an iterative process for determining whether sufficient confidence has been achieved in contribution value determinations for content evaluated by a model. The process begins with a step to get tests so far, denoted as element 901, in which the system retrieves the set of tests and observations accumulated up to the current point in the evaluation. The term “test,” as used herein, refers to an evaluation instance in which a defined input sequence is provided to the model and the resulting output is analyzed for its informational value and relevance to contribution assessment. Examples of tests may include, without limitation, input-output token pair evaluations, sequence completion tasks, or classification challenges. Following this, the method proceeds to calculate entropy at step 902, where entropy serves as a quantitative measure of unpredictability or rarity in the model's output for a given input. The term “entropy,” as used herein, refers to a statistical metric that characterizes the degree of uncertainty or information content present in a set of model outputs. Examples of entropy calculations may include, without limitation, Shannon entropy, conditional entropy, or Kolmogorov complexity-based measures. At step 903, the process calculates significance, which quantifies the informativeness or impact of the test results on the overall determination. The term “significance” refers to a measure of the importance or statistical weight of a test outcome in the context of model evaluation, often derived from information-theoretic or statistical criteria. Examples of significance measures may include, without limitation, Fisher Information, p-values, or confidence intervals. The next step, 904, involves calculating the weight of evidence, which expresses the degree to which the test results support or refute a hypothesis regarding the contribution value. The term “weight of evidence” refers to a log-likelihood ratio or other metric that quantifies the strength of support for a given hypothesis based on observed data. Examples of weight of evidence calculations may include, without limitation, log-odds ratios, Bayes factors, or likelihood ratios. At step 905, the process calculates explanatory power, which measures the extent to which the test results provide meaningful insight into the model's behavior or the underlying data relationships. The term “explanatory power” refers to the capacity of a test or set of observations to account for or explain observed outcomes in the context of model evaluation. Examples of explanatory power may include, without limitation, mutual information, information gain, or model interpretability metrics. The process then reaches a decision point at step 906, where the system evaluates whether the accumulated evidence meets a predefined confidence interval for making a determination. The term “confidence interval” refers to a statistical range within which the true value of a parameter is expected to lie with a specified probability, providing a measure of reliability for the determination. Examples of confidence intervals may include, without limitation, 95% or 99% probability bounds for estimated contribution values. If the confidence interval is satisfied, the process proceeds to report contribution value results at step 907, outputting detailed findings for each token and data point analyzed. If the confidence interval is not met, the method determines at step 908 whether additional tests should be run, thereby enabling a looped process for iterative confidence evaluation. This iterative structure ensures that the system continues to gather evidence and refine its determinations until the required level of confidence is achieved. Each step in this process correlates to claim limitations regarding the use of confidence intervals, the calculation and combination of test results, and the reporting of contribution value outcomes. Subsequent paragraphs will further elaborate on the calculations and decision points described in this flow diagram.

FIG. 10 is a schematic illustration that depicts the process of test enumeration, showing how a text datapoint is segmented into multiple input and expected-output test pairs for evaluation by a model. In this figure, highlighted input and output token sequences within an example text are indicated by reference numerals 1001 and 1002. The term “input token sequence,” as used herein, refers to a contiguous sequence of tokens selected from a datapoint that serves as the input context for a model test, while the term “output token sequence” refers to a subsequent sequence of tokens from the same datapoint that represents the expected or ground truth completion for that test. Examples of input and output token sequences may include, without limitation, the initial portion of a sentence as input and the following phrase as output, or a prompt and its corresponding answer in a question-answering context. These highlighted sequences are mapped into individual tests e, as shown by arrows, where each test is defined by a specific pairing of input and output token sequences. The term “test,” as used herein, denotes a defined evaluation instance in which a model receives a particular input token sequence and is assessed based on its ability to generate or predict the corresponding output token sequence. Examples of tests may include, without limitation, next-token prediction tasks, sequence completion challenges, or masked token recovery. The test definition expressions, indicated by reference numerals 1003 and 1004, specify the exact input and output token sequences for each enumerated test, such as e₁=[input tokens]→[output tokens]. The collection of all enumerated tests derived from the datapoint is represented by the notation E=e₁, e₂, e₃, e₄, . . . , as shown by reference numeral 1005. The term “enumerated test set,” as used herein, refers to the complete set of input-output test pairs generated from a given datapoint for systematic evaluation by the model. Examples of enumerated test sets may include, without limitation, all possible sliding window segments of a text, or all prompt-completion pairs in a dataset. A legend, designated by reference numeral 1006, is provided to clarify the graphical conventions used to distinguish input data sequences from expected output sequences in the figure. The elements depicted in FIG. 10 correspond to claim limitations regarding the definition of a plurality of tests and the partitioning of content into input and output sequences for model evaluation. Subsequent paragraphs will further elaborate on the methods and criteria for test segmentation and enumeration within the described system.

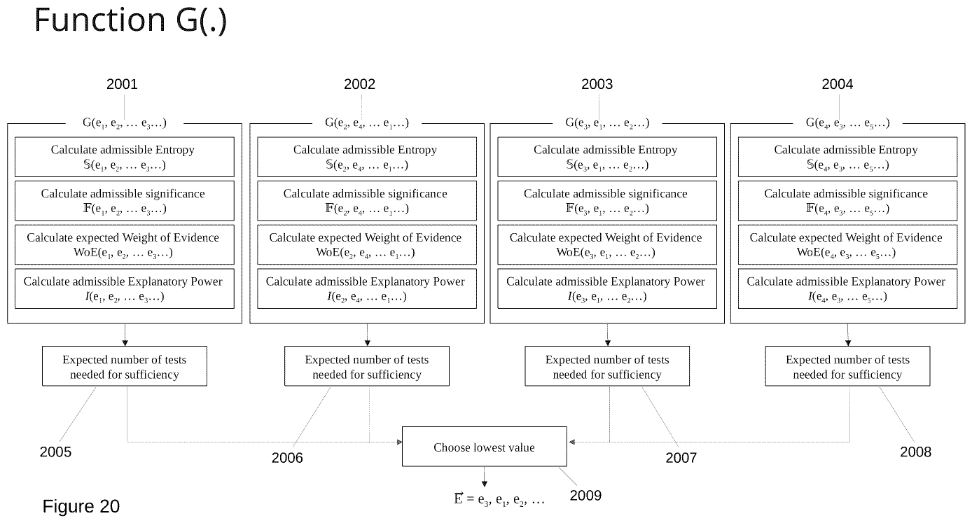

FIG. 11 is a schematic diagram illustrating the process of enumerating tests from a datapoint and sorting those tests for evaluation by an ordering function. In the example depicted, a datapoint sequence is shown starting at 1101, with several highlighted sequences indicating candidate portions that may be used to form input and output sequences for testing. The term “datapoint sequence,” as used herein, refers to a contiguous portion of content, such as a passage, score, video clip, excerpt etc., from which tests are derived for model evaluation. Examples of datapoint text sequences may include, without limitation, sentences, paragraphs, or multi-sentence blocks from documents, articles, or other textual sources. The highlighted sequences 1101 and 1102 represent specific regions within the datapoint that are selected for further analysis, and may include, without limitation, phrases, clauses, or token groupings of interest. The process continues with the explicit enumeration of tests e, as shown starting at 1103, where each test is defined by a pairing of an input token sequence and a ground truth completion. The term “enumerated test,” as used herein, refers to a defined instance in which a particular input sequence is provided to the model and the corresponding ground truth completion is identified for evaluation. Examples of enumerated tests may include, without limitation, prompt-completion pairs, masked token prediction tasks, or context-response evaluations. The designation of input and ground truth completion within each test is indicated at 1103 and 1104, where input sequences are typically marked with dashed rectangles and ground truth completions with solid rectangles, as further explained in the legend 1109. The legend provides a graphical convention for distinguishing between input data sequences, expected output sequences, and the sorted order of tests, thereby supporting clear interpretation of the figure. The collection of all enumerated tests derived from the datapoint is represented by E at 1105, where the set of tests is aggregated for subsequent processing. The term “collection of tests,” as used herein, refers to the complete set of input-output test pairs generated from a given datapoint for systematic evaluation by the model. Examples of such collections may include, without limitation, all possible sliding window segments or all prompt-completion pairs within a text segment. The test sorting function G(E), depicted at 1106, is applied to this collection to produce an ordered list of tests based on criteria such as rarity, salience, or expected contribution value. The term “test sorting function,” as used herein, refers to a computational process or algorithm that ranks or reorders tests according to predetermined metrics to optimize the sequence of evaluation. Examples of test sorting functions may include, without limitation, entropy-based ranking, information gain prioritization, or salience-based ordering. The output of the sorting function is a sorted list of tests, shown at 1107 and 1108, where the sequence of tests is arranged to maximize the efficiency and informativeness of the evaluation process. Further details on the operation of the G(.) function that performs this test sorting work flow are provided with reference FIGS. 19 and 20. The elements illustrated in FIG. 11 correspond to claim limitations regarding the performance of tests in a sorted order and the ranking of tests based on their expected contribution value. Subsequent paragraphs will address the mechanisms and criteria for test sorting and prioritization in further detail, including the role of the sorting function G(E) and the impact of test ordering on the overall evaluation methodology.

FIG. 12 is a schematic diagram that illustrates the process of test execution and logging for multiple model queries using different seeds and comparing outputs to ground truth tokens. The figure introduces input token sequence definitions at elements 1202 and 1205, where each input token sequence is provided as a distinct set of tokens to the model for evaluation. The term “input token sequence,” as used herein, refers to an ordered list of tokens derived from a datapoint, which is supplied to the model as the initial context for generating output token/encoding sequences. Examples of input token sequences may include, without limitation, sequences of tokens representing the beginning of a sentence, a prompt extracted from a document, or a segment of audio or image data converted into tokens. Model queries are performed at elements 1203 and 1206, each using a respective random seed as indicated at elements 1204 and 1207. The term “random seed,” as used herein, refers to a numerical value used to initialize the random number generator within the model, thereby enabling deterministic and reproducible output generation for a given input sequence. Examples of random seeds may include, without limitation, integer values, hash-based values, or any reproducible initialization parameter. For each model query, the system generates output token sequences, and the corresponding logits for each token are logged as shown at elements 1208 and 1209, where [L_{i,j}]1 and [L_{i,j}]2 represent the matrices of unnormalized prediction scores assigned by the model to each token in the vocabulary at each generation step. The term “logits,” as used herein, refers to the raw, unnormalized output values produced by the model prior to the application of any normalization or probability transformation, which are used to determine the likelihood of selecting each token during generation. Examples of logits may include, without limitation, real-valued scores output by neural network layers or tables of token-level prediction values. The legend at element 1210 provides a graphical convention for distinguishing between selected output tokens and ground truth tokens, facilitating comparison between the model's generated outputs and the expected results. These elements collectively correspond to claim limitations regarding the performance of a plurality of tests, the use of random seeds for deterministic model evaluation, and the comparison of model outputs to ground truth tokens. Subsequent paragraphs will further discuss the procedures for test execution and logging, including the methods for recording outputs, storing seeds, and analyzing token-level results.

FIG. 13 is a schematic diagram illustrating the execution of a test on a machine learning model to compute contribution value metrics for a datapoint sequence. As depicted, an input sequence and a ground truth completion sequence are shown at element 1301, where the input sequence represents a selected portion of the datapoint provided to the model, and the ground truth completion sequence corresponds to the expected output token/encoding sequences for that input. The term “input sequence,” as used herein, refers to a contiguous set of tokens derived from a datapoint that is supplied to the model for evaluation, and the term “ground truth completion sequence” refers to the sequence of tokens that represent the correct or reference output for the given input. Examples of input sequences may include, without limitation, the initial tokens of a sentence, a prompt extracted from a document, or a context window preceding a prediction target. Examples of ground truth completion sequences may include, without limitation, the next tokens following the input, a completion phrase, or a reference answer for evaluation. The tokenized representation of the datapoint sequence, indicated at 1302, comprises the mapping of both input and ground truth tokens to their corresponding numeric identifiers in the model's vocabulary. The term “tokenized representation” refers to a structured sequence of token identifiers that enables systematic analysis and processing by the model. Examples of tokenized representations may include, without limitation, integer sequences for text, encoded vectors for audio, or pixel groupings for images. The executor component 1303 is responsible for applying the model to the input sequence and generating an output token sequence, as well as collecting the associated logits for each token. The term “executor component,” as used herein, refers to a computational module that orchestrates the model inference process, manages input-output flows, and records relevant metrics for downstream analysis. Examples of executor components may include, without limitation, software routines for model inference, hardware accelerators for neural computation, or cloud-based execution engines. During the test execution, the system generates output token/encoding sequences, collects the logits assigned to both the selected output tokens and the ground truth tokens, along with the logit values assigned to every token/encoding in the model vocabulary, and computes a range of metrics including entropy 1308, significance 1309, and weight of evidence 1310, and explanatory power 1311. The term “logits” refers to the unnormalized prediction scores assigned by the model to each token in the vocabulary at each generation step, serving as the basis for further statistical analysis. Examples of logits may include, without limitation, real-valued outputs from neural network layers or probability scores prior to normalization. The function descriptions for entropy 1308, significance 1309, weight of evidence 1310, and explanatory power 1311 provide the mathematical formulations used to quantify each respective metric and together provide the contribution value 1307 (See FIG. 14). The legend 1312 clarifies the graphical conventions for distinguishing between selected output tokens and ground truth tokens within the diagram. The elements illustrated in FIG. 13 correspond to claim limitations regarding the execution of tests in relation to a target model and the calculation of contribution value for datapoint sequences. Subsequent paragraphs will elaborate on the computation of each metric, including the specific roles of entropy, significance, weight of evidence, and explanatory power in the overall contribution value determination process.

Table B below provides exemplary code snippets representative of many of the steps described above and with reference to FIGS. 1 through 13.

### Table B:

[B001]: import torch, random, numpy, transformers
[B002]: from tabulate import tabulate
[B003]: ## Set seed
[B004]: # [FIG. 12, 1204]
[B005]: seed=12598463
[B006]: torch.cuda.empty_cache( )
[B007]: torch.manual_seed(seed)
[B008]: torch.cuda.manual_seed(seed)
[B009]: transformers.set_seed(seed)
[n010]: random.seed(seed)
[B011]: numpy.random.seed(seed)
[B012]: ## Load model and tokenizer
[B013]: # [FIG. 2A, 205; FIG. 2B, 213]
[B014]: model=Model.from_pretrained(“model-name”, return_dict=True, torch_dtype=torch.float16, device_map=“auto”)
[B015]: ## Get model encoder
[B016]: # [FIG. 3, 302; FIG. 4, 402; FIG. 5, 502; FIG. 6, 602]
[B017]: tokenizer=Tokenizer.from_pretrained(“model-name”, return_dict=True)
[B018]: model.eval( ); model.generation_config.temperature=None; model.generation_config.top_p=None
[B019]: model.generation_config.do_sample=False; model.generation_config.pad_token_id=tokenizer.pad_token_id
[B020]: ## Datapoint
[B021]: # [FIG. 2A, 202; FIG. 2B, 210]
[B022]: datapoint=‘This is the beginning of the end’
[B023]: # [FIG. 1, 101]
[B024]: d=datapoint
[B025]: ## Input content (datapoint) into model encoder
[B026]: # [FIG. 1, 102-103; FIG. 3, 303; FIG. 4, 403; FIG. 5, 503; FIG. 6, 603]
[B027]: T_d=tokenizer.encode(d)
[B028]: ## Prepare X_in
[B029]: # [FIG. 1, 104]
[B030]: input_text=‘This is the beginning’
[B031]: # [FIG. 1, 105]
[B032]: X_in =tokenizer.encode(input_text)
[B033]: _input=torch.tensor(X_in).unsqueeze(0).to(“cuda”)
[B034]: _att=torch.tensor([1]*len(X_in)).unsqueeze(0).to(‘cuda’)
[B035]: ## Set X_y
[B036]: # FIG. 1, 105; FIG. 3, 304; FIG. 4, 404; FIG. 5, 504; FIG. 6, 604
[B037]: X_y=T_d[len(X_in):]
[B038]: # Print X_in
[B039]: indices_string
[B040]: tokens_string
[B041]: for item in X_in:
[B042]: indices_string+=‘[’+str(item).zfill(6)+‘]’
[B043]: tokens_string+=‘[’+tokenizer.decode(item)+‘]’
[B044]: print (‘X_in:’)
[B045]: print (tokens_string)
[B046]: print (indices_string)
[B047]: print ( )
[B048]: # Print X_y
[B049]: indices_string
[B050]: tokens_string
[B051]: for item in X_y:
[B052]: indices_string+=‘[’+str(item).zfill(6)+‘]’
[B053]: tokens_string+=‘[’+tokenizer.decode(item)+‘]’
[B054]: print (‘X_y:’)
[B055]: print (tokens_string)
[B056]: print (indices_string)
[B057]: print ( )
[B058]: ## M(X_in)
[B059]: # [FIG. 3, 306; FIG. 4, 406; FIG. 5, 506; FIG. 6, 607; FIG. 12, 1203]
[B060]: with torch.no_grad( ):
[B061]: model_output=model.generate(input_ids=_input, max_new_tokens=3, do_sample=False, return_dict_in_generate=True, output_scores=True, attention_mask=_att, pad_token_id=model.config.eos_token_id)
[B062]: ## [L]_i,j
[B063]: # [FIG. 12, 1208]
[B064]: logits=model_output[1]
[B065]: print(‘Ground Truth (X_in+X_y):’, d)
[B066]: print(‘Output (X_in +X_out):’, tokenizer.decode(model_output[0][0]))
[B067]: ground_truth_indices=[ ]
[B068]: # [FIG. 13, 1304]
[B069]: X_out=[ ]
[B070]: # [FIG. 13, 1305]
[B071]: Lout=[ ]
[B072]: # [FIG. 13, 1306]
[B073]: L_y=[ ]
[B074]: ## ‘Find content in [L]ij’
[B075]: # [FIG. 3, 307; FIG. 5, 509; FIG. 6, 610; FIG. 12, 1208]
[B076]: for i in range(len(logits)):
[B077]: # Sampling probabilities for each token at this time step
[B078]: _probabilities=torch.nn.functional.softmax(logits[i][−1], dim=−1)
[B079]: # Number of logits to show on the printed logit table
[B080]: show=10
[B081]: # Parse logit table at this time step
[B082]: step=torch.topk(logits[i][−1], k=tokenizer.vocab_size, dim=−1)
[B083]: step_indices=step.indices; step_logits=step.values
[B084]: step_indices_list=step_indices.tolist( )
[B085]: # Gather logit table values to print
[B086]: _step_indices_list=[str(i).zfill(6) for i in Step_indices_list[:show+1]]
[B087]: step_tokens_list=[tokenizer.decode(i) for i in step_indices_list[:show+1]]
[B088]: step_probs_list=[_probabilities[i] for i in step_indices_list[:show+1]]
[B089]: step_logits_list=step_logits.tolist( )
[B090]: # Gather ground truth/expected values
[B091]: expected_next_index=T_d[len(X_in)+i]
[B092]: ground_truth_indices.append(expected_next_index)
[B093]: expected_next_token=tokenizer.decode(T_d[len(X_in)+i])
[B094]: expected_index=step_indices_list.index(expected_next_index)
[B095]: expected_logit=step_logits_list[expected_index]
[B096]: # Gather output values
[B097]: chosen token=tokenizer.decode(step_indices_list[0])
[B098]: # [FIG. 13, 1304]
[B099]: X_out.append(step_indices_list[0])
[B100]: # [FIG. 13, 1305]
[B101]: L_out.append(step_logits_list[0])
[B102]: # [FIG. 13, 1306]
[B103]: L_y.append(expected_logit)
[B104]: # Print logit table at this generation step
[B105]: print ( )
[B106]: print (‘Generation step’, i+1)
[B107]: print ( )
[B108]: table=tabulate([[index, label, output, prob] for index, label, output, prob in zip(_step_indices_list[:show], step_tokens_list[:show], step_logits_list[:show], step_probs_list[:show])], headers=[‘Index’,‘Token’, ‘Logit’, ‘p’], tablefmt=‘orgtbl’)
[B109]: print(table)
[B110]: print ( )
[B111]: if (step_indices_list[0]==expected_next_index):
[B112]: print (‘[EQUAL]’)
[B113]: print (‘Output:’, repr(chosen token), ‘Index:’, str(_step_indices_list[0]).zfill(6), ‘Pos:’, ‘0’, ‘Logit:’, step_logits_list[0])
[B114]: print (‘Gound Truth:’, repr(expected_next_token), ‘Index:’, str(expected_next_index).zfill(6), ‘Pos:’, expected_index, ‘Logit:’, expected_logit)
[B115]: print ( )
[B116]: print (tokenizer.decode(X_out))
[B117]: print ( )
[B118]: indices_string=″
[B119]: tokens_string=″
[B120]: for item in X_out:
[B121]: indices_string+=‘[’+str(item).zfill(6)+‘]’
[B122]: tokens_string+=‘[’+tokenizer.decode(item)+‘]’
[B123]: print ( )
[B124]: print (‘X_out:’)
[B125]: print (tokens_string)
[B126]: print (indices_string)
[B127]: print ( )
[B128]: print (‘L_y:’)
[B129]: print (L_y)
[B130]: print ( )
[B131]: print (‘Lout:’)
[B132]: print (Lout)
[B133]: print ( )
[B134]: # Example calculation on logit table (common training objective)
[B135]: target=torch.tensor(ground_truth_indices, dtype=torch.int64)
[B136]: cross_entropy=torch.nn.functional.cross_entropy(torch.stack(logits).squeeze( ).to(‘cuda’), target.to(‘cuda’))
[B137]: print (‘Cross Entropy:’, float(cross_entropy))

Table C below is an illustrative example output generated using the code snippets in Table B, executing many of the steps described above and in FIGS. 1 through 13.

### Table C:

X_in:
[This] [is] [the] [beginning]
[001212] [000318] [000262] [003726]
X_y:
[of] [the] [end]
[000286] [000262] [000886]
Ground Truth (X_in+X_y): This is the beginning of the end
Output (X_in+X_out): This is the beginning of a new
Generation step 1
   |Index|Token|Logit|p|
   |---------+---------+----------+------------|
   |000286|of|2.6406|0.866907|
   |000013|.|9.3125|0.0310875|
   |000011|,|9.11719|0.0255719|
   |000290|and|8.15625|0.00978212|
   |000553|,″|8.11719|0.00940738|
   |000329|for|7.875|0.00738394|
   |000526|.″|7.79297|0.0068024|
   |000284|to|7.13281|0.00351528|
   |000001|″|6.60547|0.00207461|
   |000000|!|6.57422|0.00201079|
[EQUAL]
Output: ‘of’ Index: 000286 Pos: 0 Logit: 12.640625
Gound Truth: ‘of’ Index: 000286 Pos: 0 Logit: 12.640625
of
Generation step 2
Index|Token|Logit|p|
   |---------+-----------+----------+------------|
   |000257|a|10.3984|0.346056|
   |000262|the|10.3281|0.322559|
   |000674|our|8.26562|0.0410088|
   |000281|an|8.24219|0.0400589|
   |001223|something|7.73828|0.0242022|
   |000644|what|7.65234|0.0222092|
   |000616|my|7.55859|0.0202217|
   |000534|your|7.01953|0.0117952|
   |001194|another|6.42188|0.00648854|
   |000428|this|6.31641|0.00583905|
Output: ‘a’ Index: 000257 Pos: 0 Logit: 10.3984375
Gound Truth: ‘ the’ Index: 000262 Pos: 1 Logit: 10.328125
of a
Generation step 3
   |Index|Token|Logit|p|
   |---------+---------+----------+-----------|
   |000649|new|11.1406|0.322485|
   |000890|long|9.35938|0.0543153|
   |000845|very|8.77344|0.030231|
   |002168|series|8.25781|0.0180518|
   |007002|journey|8.14062|0.0160556|
   |002187|whole|8.07031|0.0149654|
   |001429|process|8|0.0139493|
   |001049|great|7.94922|0.0132586|
   |001621|story|7.91797|0.0128507|
   |000734|two|7.6875|0.0102055|
Output: ‘new’ Index: 000649 Pos: 0 Logit: 11.140625
Gound Truth: ‘ end’ Index: 000886 Pos: 2142 Logit: 1.4892578125
of a new
X_out:
[of] [a] [new]
[000286] [000257] [000649]
L_y:
[12.640625, 10.328125, 1.4892578125]
L_out:
[12.640625, 10.3984375, 11.140625]
Cross Entropy: 4.019119739532471

FIG. 14 is a diagram that illustrates example equations for computing the value contribution of an entire datapoint as well as for individual tests within the model evaluation process. The figure presents two value function equations, labeled 1401 and 1402, which serve as the mathematical basis for quantifying contribution value. The term “value function,” as used herein, refers to a composite mathematical expression that aggregates multiple metrics to produce a single quantitative measure representing the informational contribution of content or test results to a model. Examples of value functions may include, without limitation, summations or weighted combinations of statistical metrics such as entropy, significance, weight of evidence, and explanatory power. In the context of FIG. 14, the value function V(E,O) combines the contributions from entropy S(E,O), significance F(E,O), weight of evidence WoE(E,O), and explanatory power I(E,O), either as a direct sum (as shown in equation 1401) or as a weighted sum with respective weighting factors (as shown in equation 1402). The term “entropy,” as used herein, refers to a measure of unpredictability or information content in the model's outputs, while “significance” denotes the informativeness or statistical impact of a test result. The term “weight of evidence” refers to a metric quantifying the strength of support for a hypothesis based on observed data, and “explanatory power” refers to the degree to which observed results account for or explain model behavior. Examples of entropy may include, without limitation, Shannon entropy or conditional entropy; examples of significance may include, without limitation, Fisher Information Matrix or Jeffrey's prior; examples of weight of evidence may include, without limitation, log-likelihood ratios or Bayes factors; and examples of explanatory power may include, without limitation, mutual information or information gain. The equations depicted in FIG. 14 correspond to claim limitations regarding the combination of test results and the aggregation of contribution values for both individual output token/encoding sequences and entire datapoints. Subsequent paragraphs will discuss in detail the mathematical basis for each component of the value function and the computation of contribution value within the described system.

FIG. 15 is a diagram illustrating Shannon entropy formulations that are used to characterize model output behavior. The figure presents two principal entropy expressions: a first equation 1501 that defines the entropy H(X not in D_{M}) for model outputs, and a second equation 1502 that defines the conditional entropy H(Y|X not in D_{M}) for model outputs given preceding input token sequences. The term “entropy,” as used herein, refers to a quantitative measure of unpredictability or information content in a set of model outputs, and is used to assess the rarity or typicality of specific token sequences generated by the model. Examples of entropy may include, without limitation, Shannon entropy, conditional entropy, Kolmogorov complexity, or other information-theoretic metrics that evaluate the distribution of token occurrences. In the equations depicted in FIG. 15, entropy is calculated using token counts kₓᵢ and joint counts k_{xi,yi}, together with logarithmic terms that reflect observation frequencies relating to particular tokens or token pairs in the model's output. The use of these counts and log terms enables the system to quantify how frequently certain outputs occur when the model is queried with data not present in its training set or not included in the context window during inference, thereby supporting determinations of rarity and entropy as required by the claim limitations. Subsequent paragraphs will elaborate further on the methods and calculations for entropy, including the interpretation and application of these formulas within the described system.

FIG. 16 provides a schematic representation of a significance function that implements a variation of Fisher Information calculations within the valuation algorithm described herein. The term “significance function,” as used herein, refers to a computational process or algorithm that quantifies the informativeness or impact of a test result by evaluating the sensitivity of model outputs to changes in underlying parameters, thereby supporting determinations of how much information a particular observation provides about the model. Examples of significance functions may include, without limitation, algorithms that compute Fisher Information, expected information gain, or other information-theoretic measures of test impact. In the context of FIG. 16, the Fisher Information equations 1601 and 1602 are introduced as the mathematical basis for this significance function. Equation 1601 expresses Fisher Information I(θ) as the expected value of the squared gradient of the log-likelihood function with respect to a parameter θ, while equation 1602 generalizes this to the Fisher Information matrix, which captures the expected product of gradients for multiple parameters. The term “Fisher Information,” as used herein, refers to a statistical measure of the amount of information that an observable random variable carries about an unknown parameter, and is commonly used to assess the precision with which model parameters can be estimated from data. Examples of Fisher Information may include, without limitation, scalar measures for single-parameter models or matrix-valued measures for multi-parameter systems. The use of expected squared gradients and Fisher Information matrices in the significance function enables the system to systematically evaluate the impact of individual tests in relation to a target model's parameter space, thereby providing a rigorous basis for determining significance in the context of contribution value analysis. These equations and their implementation directly correspond to claim limitations regarding determinations of significance for model evaluation. Subsequent paragraphs will discuss the computation of significance in further detail, including the operational role of the significance function within the overall valuation algorithm.

FIG. 17 is a diagram illustrating a mathematical definition of weight of evidence used in evaluating tests on a model. The figure presents the weight of evidence equation 1701, which expresses weight of evidence as a log likelihood ratio between the likelihood or frequency of an observation given a first hypothesis and the likelihood or frequency of the same observation given an alternative hypothesis. The term “weight of evidence,” as used herein, refers to a quantitative metric that measures the strength of support for one hypothesis over another based on observed data, and is computed as the base-2 logarithm of the ratio of these conditional likelihoods or frequencies. Examples of weight of evidence may include, without limitation, log-likelihood ratios calculated for determining whether a particular input-output token sequence is more likely to have originated from a model trained on specific content or from a model that has not seen that content (either during training or inference). In the context of the present system, the probabilities used in the weight of evidence calculation may be derived from the observed outputs of the model under different hypotheses regarding the presence or absence of the content in the training data or in the context window during inference. This approach directly correlates to claim limitations that require determinations for weight of evidence as part of the plurality of tests performed in relation to a target model. Subsequent paragraphs will elaborate in further detail on the methods and calculations for determining weight of evidence within the described system.

FIG. 18 provides a schematic representation of explanatory power and information value as expressed through mutual information formulations, illustrating how these concepts are quantified and incorporated into the overall contribution value analysis of a model. The term “explanatory power,” as used herein, refers to the capacity of a hypothesis or model to account for observed outcomes or data, typically measured in terms of mutual information between the hypothesis and the evidence. Examples of explanatory power may include, without limitation, the mutual information between the presence of a specific content sequence in the training data (or context-window inputs) and the observed model outputs, or the information gain associated with testing a particular input-output token pair. The figure introduces a sequence of equations, including equation 1801, which defines mutual information I(H:E) as the logarithm of the ratio of the likelihood or frequency of observing evidence E given hypothesis H to the likelihood or frequency of observing E alone. Equation 1802 further refines explanatory power by incorporating a weighted information term, subtracting a scaled value of the information content of the hypothesis from the mutual information. Equations 1803 through 1805 present additional equivalent formulations, expressing explanatory power in terms of conditional information, differences of information measures, and log likelihood ratios with weighted adjustments. The term “mutual information,” as used herein, refers to a statistical measure that quantifies the amount of information obtained about one random variable through another, serving as a foundational metric for evaluating the informativeness of model observations. Examples of mutual information may include, without limitation, the reduction in uncertainty about whether a datapoint was used during training or inference given the model's outputs, or the information shared between input token sequences and generated output sequences. The use of log likelihood ratios and weighted information terms in these equations enables the system to flexibly account for both the strength and relevance of evidence when determining explanatory power. These formulations directly correlate to claim limitations requiring determinations for explanatory power as part of the plurality of tests performed in relation to a target model. Subsequent paragraphs will further elaborate on the computation of explanatory power and information value, including their operational roles within the described system and method.

FIGS. 19 and 20 relate to the workflow for obtaining a sorted test sequence by the G(.) function. The sufficiency determination and selection of the optimal test sequence, as illustrated by elements 1907 and 1908 in FIG. 19, provides an approach for evaluating whether enough evidence has been gathered to make a confident determination regarding the contribution value of content to a model. The term “sufficient statistic,” as used herein, refers to a summary measure or set of measures that captures all relevant information from the accumulated test results needed to make a statistical inference about the contribution value or uniqueness of the expected observations. Examples of sufficient statistics may include, without limitation, cumulative information metrics, sample means, sums, squared sums, or confidence interval bounds derived from the results of the plurality of tests. The decision process at element 1906 involves assessing whether the results of the performed tests meet a predefined statistical threshold, such as a confidence interval, that ensures the reliability of the determination. The term “confidence interval” refers to a statistical range within which the true value of a parameter is expected to lie with a specified probability, providing a measure of certainty for the evaluation outcome. Examples of confidence intervals may include, without limitation, 95% or 99% probability bounds for estimated contribution values or uniqueness metrics. When the sufficiency condition is not met, the system continues to perform additional tests, thereby iteratively refining the determination until the required confidence level is achieved. Once sufficiency is established, the procedure involves determining the number of tests required to reach this threshold and selecting the test sequence that achieves sufficiency with the lowest number of tests as the ordered sequence for evaluation. The term “ordered sequence,” as used herein, refers to a specific arrangement of tests prioritized to maximize efficiency in reaching a statistically sufficient determination. Examples of ordered sequences may include, without limitation, test orderings based on expected contribution value, rarity, or information gain. This process directly relates to claim limitations regarding performing tests until sufficient confidence is determined and ranking tests based on their expected contribution value. By selecting the test sequence that minimizes the number of required tests, the system achieves both efficiency and optimization, reducing computational effort while ensuring robust and reliable content valuation.

Specifically, with reference to FIG. 19 the steps are as follows. The method is bounded by a start node 1901 and an end node 1909, which respectively mark the initiation and completion of the test sequence selection process. The process begins by obtaining input sequences for the tests at step 1902, followed by randomizing the sequence order of the tests at step 1903 to support unbiased evaluation and to explore different possible test orderings. The term “randomizing the sequence order,” as used herein, refers to the process of rearranging the set of defined tests into a non-deterministic order to reduce bias and ensure that the evaluation does not favor any particular sequence or data segment. Examples of randomization procedures may include, without limitation, shuffling the test indices using a pseudo-random number generator, applying permutation algorithms, or sampling test sequences without replacement. This preparatory step is critical for establishing a robust and unbiased foundation for subsequent evaluation, as it enables the system to fairly assess the contribution value of content across a diverse set of test scenarios.

At step 1904, for each randomized test sequence, the system performs calculations for rarity, salience, weight of evidence, and explanatory power, which are used to assess the expected informational value and efficiency of each sequence. The performance of the calculations is optional since not all of these calculations may need to be performed to get a sufficient observation. At decision point 1906, the method determines whether a sufficient statistic has been obtained, meaning that enough evidence has been collected to make a confident determination regarding the contribution value or uniqueness of the expected observations. If sufficiency is not reached, the process may iterate through additional randomized test sequences. Once sufficiency is achieved, the method proceeds to step 1907, where the test sequence requiring the lowest number of tests to reach sufficiency is selected as the ordered sequence for evaluation. These steps collectively enable the system to efficiently determine an optimal sequence of tests that achieves statistical sufficiency with minimal computational effort, thereby supporting claim limitations related to the definition, ordering, and ranking of a plurality of tests, as well as the use of various evaluation metrics.

FIG. 20 is a flow diagram that further illustrates the operation of the sorting function G(.) for ordering tests based on expected sufficiency, providing an approach for optimizing the order in which tests are performed during model evaluation. The figure depicts the evaluation of multiple candidate test segment orderings, including a first ordering 2001, a second ordering 2002, a third ordering 2003, and a fourth ordering 2004, where each ordering is assessed by calculating one or more calculations including entropy, significance, expected weight of evidence, and/or explanatory power. The term “sorting function,” as used herein, refers to a computational process or algorithm that determines an optimal order for performing a plurality of tests so as to minimize the number of tests required to achieve statistical sufficiency in model evaluation. Example functions may include, without limitation, algorithms that rank test segments by expected information gain, prioritize segments with rare or salient features, or employ combinatorial optimization to identify efficient test sequences. For each test segment ordering, the system calculates the expected number of tests needed to reach sufficiency, as shown by elements 2005, 2006, 2007, and 2008, thereby quantifying the efficiency of each candidate ordering. The term “expected number of tests needed for sufficiency” refers to a statistical estimate of how many tests must be performed, in a given order, before a sufficient statistic is obtained for reliable determination of contribution value or uniqueness. Examples of such estimates may include, without limitation, confidence interval calculations, cumulative information thresholds, or stopping criteria based on observed evidence. At the selection step 2009, the segment ordering with the lowest expected number of tests is chosen as the ordered list of tests, ensuring that the evaluation process is both efficient and robust. The term “ordered list of tests” refers to a prioritized sequence of test segments determined by the sorting function to optimize sufficiency and minimize computational effort. Examples of ordered lists of tests may include, without limitation, test sequences sorted by expected contribution value, rarity, or explanatory power.

According to one embodiment of the present disclosure, a method for determining a contribution value of content used to train a machine learning model, the method includes: receiving, by a processor, a model encoder for the model; inputting, by the processor, content including input sequences and corresponding ground truths into the model encoder; encoding, by the model encoder, the content to obtain a sequence of encodings representative of the content; defining, by the processor, a plurality of tests to be performed in relation to the model with each input sequence of the content to obtain one or more corresponding output encodings, wherein the plurality of tests include determinations for rarity or salience; combining, by the processor, results of the plurality of tests for each output encoding sequence to obtain a value representative of a contribution value for the output encoding sequence to the model; and combining, by the processor, the contribution values for the output encoding sequences of the content to obtain a value representative of the contribution value of the content to the model.

The input sequence may include text, audio, video, images, music, or other data and the step of encoding further includes at least one of: tokenizing text of the input sequence to obtain a sequence of tokens representative of the content; computing feature maps of video and images; and computing feature vectors of audio and music.

Performing the plurality of tests may include performing the plurality of tests in a sorted order.

Performing the plurality of tests may include performing the plurality of tests until sufficient confidence of the tests is determined.

Performing the plurality of tests may include determinations for significance, entropy, weight of evidence, or explanatory power.

Tests for significance, entropy, weight of evidence or explanatory power may be performed to determine a sorted order of the tests.

Sorting the plurality of tests may further include ranking each of the tests based on their expected contribution value to ensure sufficient confidence is reached by the plurality of tests.

Combining the plurality of test results for each output encoding sequence to obtain a value representative of the contribution value for the output encoding sequence may further include determinations for significance, entropy, weight of evidence, and explanatory power.

Combining the contribution values for the output encoding sequences of the content to obtain a value representative of the contribution value may further include determinations for significance, entropy, weight of evidence, and explanatory power.

The determinations for significance and entropy include comparing the output encoding sequences with the ground truth encoding sequences for a corresponding input sequence.

The model may include a model vocabulary and performing determinations for weight of evidence and explanatory power further includes comparing one of the plurality of tests with the model vocabulary.

Performing the plurality of tests may further include performing the plurality of tests to determine whether the content was used to train the model.

The model may include a random number generator and a seed for the random number generator, and further includes determining whether one or more output encoding sequences for the corresponding input sequence are verbatim to the ground truths for the input sequence and storing the input sequence, the verbatim output encoding sequences, and the seed used for the model.

According to one embodiment of the present disclosure, a method for determining whether content was used by a model during training or inference includes: receiving, by a processor, a model encoder for the model, wherein the model includes a random number generator and a seed for the random number generator; inputting, by the processor, content including input sequences and corresponding ground truths into the model encoder; encoding, by the model encoder, the content to obtain a series of encoding sequences representative of the content; defining, by the processor, a plurality of tests to be performed in relation to the model with each input sequence of the content to obtain one or more corresponding output tokens, wherein the plurality of tests include determinations for rarity or salience; and evaluating, by the processor, results of the plurality of tests for each input sequence to determine whether the input sequence was used to train the model.

Evaluating the plurality of tests to determine whether the input sequence was used by the model during training or inference may further include determining whether the one or more output encoding sequences for the corresponding input sequence are verbatim to the ground truths for the input sequence and storing the input sequence and the seed used by the model.

Evaluating the plurality of tests to determine whether the input sequence was used by the model during training or inference may further include: supplying the input sequences to the model to compute a plurality of logits; and finding the corresponding ground truths for the input sequence in the plurality of logits.

The method may further include combining the plurality of test results for each encoding token to obtain a value representative of a contribution value for the output encoding sequence to the model.

The method may further include combining the contribution values for the output encoding sequences of the content to obtain a value representative of a contribution value of the content to the model.

According to one embodiment of the present disclosure, a system for determining a contribution value of content used by a model during training or inference includes: a processor to supply input sequences to the model and obtain corresponding outputs from the model; a model encoder for the model, configured to encode the content into a sequence of encodings representative of the content; the processor being further configured to perform a plurality of tests in relation to the model with each input sequence of the content to obtain one or more corresponding output encoding sequences, wherein the plurality of tests include determinations for rarity or salience; the processor being further configured to combine results of the plurality of tests for each output encoding sequence to obtain a value representative of a contribution value for the output encoding sequence to the model; and the processor being further configured to combine the contribution values for the output encoding sequences of the content to obtain a value representative of the contribution value of the content to the model.

The processor may include a graphics processing unit or CPU.

The processor may be located locally on a computer or remotely on a cloud-based server system.

The input sequence may include text, audio, video, images, music, or other data.

The processor may be further configured to perform the plurality of tests in a sorted order and the model encoder for the model may be further configured to tokenize the content into a sequence of tokens representative of the content.

The processor may be further configured to perform the plurality of tests until sufficient confidence of the tests is determined.

The processor may be further configured to perform determinations for significance, entropy, weight of evidence, or explanatory power.

The processor may perform tests for significance and entropy to determine a sorted order of the tests.

The processor may be further configured to rank each of the tests based on their expected contribution value to ensure sufficient confidence is reached by the plurality of tests.

The processor may be further configured to combine the plurality of test results for each output encoding sequence to obtain a value representative of the contribution value for the output encoding sequence, further including determinations for significance, entropy, weight of evidence, and explanatory power.

The processor may be further configured to combine the contribution values for the output encoding sequences of the content to obtain a value representative of the contribution value, further including determinations for significance, entropy, weight of evidence, and explanatory power.

The processor may be further configured to compare the output encoding sequences with a plurality of ground truth tokens for a corresponding input sequence in performing determinations for significance and entropy.

The model may include a model vocabulary and the processor may be further configured to compare one of the plurality of tests with the model vocabulary in performing determinations for weight of evidence and explanatory power.

The processor may be further configured to perform the plurality of tests to determine whether the content was used to train the model.

The model may include a random number generator and a seed for the random number generator, and the processor is further configured to determine whether the one or more output encoding sequences for the corresponding input sequence are verbatim to corresponding ground truths for the input sequence.

The processor may be further configured to store the input sequence, verbatim output encoding sequences, and the seed used for the model.

According to one embodiment of the present disclosure, a system for determining whether content was used by a model during training or inference the system includes: a processor configured to supply input sequences to the model and obtain corresponding outputs from the model, wherein the model includes a random number generator and a seed for the random number generator; a model encoder for the model, configured to encode the content into a sequence of encodings representative of the content; the processor further configured to perform a plurality of tests in relation to the model with each input sequence of the content to obtain one or more corresponding output encoding sequences, wherein the plurality of tests include determinations for rarity or salience; and the processor further configured to evaluate results of the plurality of tests for each input sequence to determine whether the input sequence was used by the model during training or inference.

The processor may be further configured to determine whether the one or more output encoding sequences for the corresponding input sequence are verbatim to corresponding ground truths for the input sequence.

The processor may be further configured to store the input sequence, verbatim output encoding sequences, and the seed used for the model.

The processor may be further configured to combine the plurality of test results for each output encoding sequence to obtain a value representative of a contribution value for the output encoding sequence to the model.

The processor may be further configured to combine the contribution values for the output encoding sequences of the content to obtain a value representative of a contribution value of the content to the model.

The processor may include a graphics processing unit or CPU.

The processor may be located locally on a computer or remotely on a cloud-based server system.

The input sequence may include text, audio, video, images, music, or other data and the model encoder for the model, configured to perform at least one of tokenizing the content into token sequences representative of the content; computing feature maps of video and images; and computing feature vectors of audio and music.

According to one embodiment of the present disclosure, a non-transitory computer-readable medium storing instructions that, when executed by one or more processors, causes the system to determine the expected information gain for a datapoint used by a model during training or inference including: receiving the model and the datapoint as input; encoding the datapoint and dividing it into segments for testing; sequencing the segments into a sorted order for input to the model; and testing the model with each segment to obtain output encoding sequences and logit values by computing entropy, significance, weight of evidence, or explanatory power to determine the expected information gain.

The non-transitory computer-readable medium may further store instructions that, when executed by one or more processors, further cause the one or more processors to perform the step to determine whether the datapoint was seen during training or inference, terminating the tests when sufficient evidence is obtained or reporting inconclusive if not.

The input sequence may include text, audio, video, images, music, or other data and the step of encoding further includes at least one of: tokenizing the input sequence to obtain a sequence of tokens representative of the content; computing feature maps of video and images; and computing feature vectors of audio and music.

Sequencing the segments into the sorted order may include ranking each of the segments based on their expected contribution value to ensure sufficient evidence is reached by the segments.

The model may include a model vocabulary, and wherein the instructions to compute the weight of evidence and the explanatory power further include instructions to compare one of the segments with the model vocabulary.

The term non-transitory computer-readable medium is to be understood herein to refer to one or more non-transitory computer-readable media, such as a single solid-state drive, multiple solid-state drives connected in a redundant array of independent drives, one or more hard disk drives (e.g., magnetic data storage media), one or more optical (e.g., CD-ROM or DVD-ROM) media, one or more pools of data storage devices connected to one or more computer servers, and the like.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A method for determining a contribution value of content used to train a machine learning model, the method comprising:
receiving, by a processor, a model encoder for the model;
inputting, by the processor, content comprising input sequences and corresponding ground truths into the model encoder;
encoding, by the model encoder, the content to obtain a sequence of encodings representative of the content;
defining, by the processor, a plurality of tests to be performed in relation to the model with each input sequence of the content to obtain one or more corresponding output encodings, wherein the plurality of tests comprise determinations for rarity or salience;
combining, by the processor, results of the plurality of tests for each output encoding sequence to obtain a value representative of a contribution value for the output encoding sequence to the model; and
combining, by the processor, the contribution values for the output encoding sequences of the content to obtain a value representative of the contribution value of the content to the model.

2. The method of claim 1, wherein the input sequence comprises text, audio, video, images, music, or other data and the step of encoding further comprises at least one of: tokenizing text of the input sequence to obtain a sequence of tokens representative of the content; computing feature maps of video and images; and computing feature vectors of audio and music.

3. The method of claim 1, wherein performing the plurality of tests comprises performing the plurality of tests in a sorted order.

4. The method of claim 1, wherein performing the plurality of tests comprises performing the plurality of tests until sufficient confidence of the tests is determined.

5. The method of claim 1, wherein performing the plurality of tests comprises determinations for significance, entropy, weight of evidence, or explanatory power.

6. The method of claim 5, wherein tests for significance, entropy, weight of evidence or explanatory power are performed to determine a sorted order of the tests.

7. The method of claim 3 or 6, wherein sorting the plurality of tests further comprises ranking each of the tests based on their expected contribution value to ensure sufficient confidence is reached by the plurality of tests.

8. The method of claim 1, wherein combining the plurality of test results for each output encoding sequence to obtain a value representative of the contribution value for the output encoding sequence further comprises determinations for significance, entropy, weight of evidence, and explanatory power.

9. The method of claim 1, wherein combining the contribution values for the output encoding sequences of the content to obtain a value representative of the contribution value further comprises determinations for significance, entropy, weight of evidence, and explanatory power.

10. The method of claim 8 or 9, wherein determinations for significance and entropy comprise comparing the output encoding sequences with the ground truth encoding sequences for a corresponding input sequence.

11. The method of claim 8 or 9, wherein the model comprises a model vocabulary and performing determinations for weight of evidence and explanatory power further comprises comparing one of the plurality of tests with the model vocabulary.

12. The method of claim 1, wherein performing the plurality of tests further comprises performing the plurality of tests to determine whether the content was used to train the model.

13. The method of claim 12, wherein the model comprises a random number generator and a seed for the random number generator, and further comprises determining whether one or more output encoding sequences for the corresponding input sequence are verbatim to the ground truths for the input sequence and storing the input sequence, the verbatim output encoding sequences, and the seed used for the model.

14. A method for determining whether content was used by a model during training or inference, the method comprising:
receiving, by a processor, a model encoder for the model, wherein the model comprises a random number generator and a seed for the random number generator;
inputting, by the processor, content comprising input sequences and corresponding ground truths into the model encoder;
encoding, by the model encoder, the content to obtain a series of encoding sequences representative of the content;
defining, by the processor, a plurality of tests to be performed in relation to the model with each input sequence of the content to obtain one or more corresponding output tokens, wherein the plurality of tests comprise determinations for rarity or salience; and
evaluating, by the processor, results of the plurality of tests for each input sequence to determine whether the input sequence was used to train the model.

15. The method of claim 14, wherein evaluating the plurality of tests to determine whether the input sequence was used by the model during training or inference further comprises determining whether the one or more output encoding sequences for the corresponding input sequence are verbatim to the ground truths for the input sequence and storing the input sequence and the seed used by the model.

16. The method of claim 14, wherein evaluating the plurality of tests to determine whether the input sequence was used by the to train the model during training or inference further comprises:
supplying the input sequences to the model to compute a plurality of logits; and
finding the corresponding ground truths for the input sequence in the plurality of logits.

17. The method of claim 14 or 15, further comprising combining the plurality of test results for each encoding token to obtain a value representative of a contribution value for the output encoding sequence to the model.

18. The method of claim 14 or 15, further comprising combining the contribution values for the output encoding sequences of the content to obtain a value representative of a contribution value of the content to the model.

19. A system for determining a contribution value of content used by a model during training or inference, the system comprising:
a processor to supply input sequences to the model and obtain corresponding outputs from the model;
a model encoder for the model, configured to encode the content into a sequence of encodings representative of the content;
the processor being further configured to perform a plurality of tests in relation to the model with each input sequence of the content to obtain one or more corresponding output encoding sequences, wherein the plurality of tests comprise determinations for rarity or salience;
the processor being further configured to combine results of the plurality of tests for each output encoding sequence to obtain a value representative of a contribution value for the output encoding sequence to the model; and
the processor being further configured to combine the contribution values for the output encoding sequences of the content to obtain a value representative of the contribution value of the content to the model.

20. The system of claim 19, wherein the processor comprises a graphics processing unit or CPU.

21. The system of claim 20, wherein the processor is located locally on a computer or remotely on a cloud-based server system.

22. The system of claim 19, wherein the input sequence comprises text, audio, video, images, music, or other data.

23. The system of claim 19, wherein the processor is further configured to perform the plurality of tests in a sorted order and the model encoder for the model, configured to tokenize the content into a sequence of tokens representative of the content.

24. The system of claim 19, wherein the processor is further configured to perform the plurality of tests until sufficient confidence of the tests is determined.

25. The system of claim 19, wherein the processor is further configured to perform determinations for significance, entropy, weight of evidence, or explanatory power.

26. The system of claim 25, wherein the processor performs tests for significance and entropy to determine a sorted order of the tests.

27. The system of claim 23 or 24, wherein the processor is further configured to rank each of the tests based on their expected contribution value to ensure sufficient confidence is reached by the plurality of tests.

28. The system of claim 19, wherein the processor is further configured to combine the plurality of test results for each output encoding sequence to obtain a value representative of the contribution value for the output encoding sequence, further comprising determinations for significance, entropy, weight of evidence, and explanatory power.

29. The system of claim 19, wherein the processor is further configured to combine the contribution values for the output encoding sequences of the content to obtain a value representative of the contribution value, further comprising determinations for significance, entropy, weight of evidence, and explanatory power.

30. The system of claim 28 or 29, wherein the processor is further configured to compare the output encoding sequences with a plurality of ground truth tokens for a corresponding input sequence in performing determinations for significance and entropy.

31. The system of claim 28 or 29, wherein the model comprises a model vocabulary and the processor is further configured to compare one of the plurality of tests with the model vocabulary in performing determinations for weight of evidence and explanatory power.

32. The system of claim 19, wherein the processor is further configured to perform the plurality of tests to determine whether the content was used to train the model.

33. The system of claim 32, wherein the model comprises a random number generator and a seed for the random number generator, and the processor is further configured to determine whether the one or more output encoding sequences for the corresponding input sequence are verbatim to corresponding ground truths for the input sequence.

34. The system of claim 33, wherein the processor is further configured to store the input sequence, verbatim output encoding sequences, and the seed used for the model.

35. A system for determining whether content was used by a model during training or inference the system comprising:
a processor configured to supply input sequences to the model and obtain corresponding outputs from the model, wherein the model comprises a random number generator and a seed for the random number generator;
a model encoder for the model, configured to encode the content into a sequence of encodings representative of the content;
the processor further configured to perform a plurality of tests in relation to the model with each input sequence of the content to obtain one or more corresponding output encoding sequences, wherein the plurality of tests comprise determinations for rarity or salience; and
the processor further configured to evaluate results of the plurality of tests for each input sequence to determine whether the input sequence was used by the model during training or inference.

36. The system of claim 35, wherein the processor is further configured to determine whether the one or more output encoding sequences for the corresponding input sequence are verbatim to corresponding ground truths for the input sequence.

37. The system of claim 36, wherein the processor is further configured to store the input sequence, verbatim output encoding sequences, and the seed used for the model.

38. The system of claim 35 or 36, wherein the processor is further configured to combine the plurality of test results for each output encoding sequence to obtain a value representative of a contribution value for the output encoding sequence to the model.

39. The system of claim 35 or 36, wherein the processor is further configured to combine the contribution values for the output encoding sequences of the content to obtain a value representative of a contribution value of the content to the model.

40. The system of claim 35, wherein the processor comprises a graphics processing unit or CPU.

41. The system of claim 40, wherein the processor is located locally on a computer or remotely on a cloud-based server system.

42. The system of claim 35, wherein the input sequence comprises text, audio, video, images, music, or other data and the model encoder for the model, configured to perform at least one of tokenizing the content into token sequences representative of the content; computing feature maps of video and images; and computing feature vectors of audio and music.

43. A non-transitory computer-readable medium storing instructions that, when executed by one or more processors, causes the system to determine the expected information gain for a datapoint used by a model during training or inference comprising:
receiving the model and the datapoint as input;
encoding the datapoint and dividing it into segments for testing;
sequencing the segments into a sorted order for input to the model; and
testing the model with each segment to obtain output encoding sequences and logit values by computing entropy, significance, weight of evidence, or explanatory power to determine the expected information gain.

44. The non-transitory computer-readable medium of claim 43 further storing instructions that, when executed by one or more processors, further cause the one or more processors to perform the step to determine whether the datapoint was seen during training or inference, terminating the tests when sufficient evidence is obtained or reporting inconclusive if not.

45. The non-transitory computer-readable medium of claim 43, wherein the input sequence comprises text, audio, video, images, music, or other data and the step of encoding further comprises at least one of: tokenizing the input sequence to obtain a sequence of tokens representative of the content; computing feature maps of video and images; and computing feature vectors of audio and music.

46. The non-transitory computer-readable medium of claim 43, wherein sequencing the segments into the sorted order comprises ranking each of the segments based on their expected contribution value to ensure sufficient evidence is reached by the segments.

47. The non-transitory computer-readable medium system of claim 43, wherein the model comprises a model vocabulary, and wherein the instructions to compute the weight of evidence and the explanatory power further comprise instructions to compare one of the segments with the model vocabulary.
